(19) United States
(12) Patent Application Publication
(10) Pub. No.: US 2017/0186132 A1
(43) Pub. Date: Jun. 29, 2017

(54) FLEXIBLE ELECTRONIC DEVICE AND DISPLAYING METHOD THEREOF

(71) Applicant: Samsung Electronics Co., Ltd., Suwon-si (KR)

(72) Inventors: Chaekyung LEE, Seoul (KR); Sun-Young YI, Seongnam-si (KR); Heejin KIM, Seoul (KR); Dongjun SHIN, Seoul (KR); Ha-Young JEON, Seoul (KR)

(21) Appl. No.: 15/388,462

(22) Filed: Dec. 22, 2016

(30) Foreign Application Priority Data
Dec. 28, 2015 (KR) 10-2015-0187722

(51) Int. Cl. G06T 3/20; G06F 1/16

(52) U.S. Cl. CPC G06T 3/20; G06F 1/163; G06F 1/1652; G06F 1/1694; G06F 1/1643; G06F 3/041

(57) ABSTRACT

A flexible electronic device and an operation method thereof are provided. The flexible electronic device includes a flexible display, and a processor operatively coupled to the display. The processor can detect a position of a fastening part of the electronic device, set a display region of the display, and display screen information in the display region.

### CROSS-REFERENCE TO RELATED APPLICATION(S)

This application claims the benefit under 35 U.S.C. §119(a) of a Korean patent application filed on Dec. 28, 2015 in the Korean Intellectual Property Office and assigned Serial number 10-2015-0187722, the entire disclosure of which is hereby incorporated by reference.

### TECHNICAL FIELD

The present disclosure relates to a flexible electronic device and an operation method thereof.

### BACKGROUND

Recently, with the growth of digital technologies, various types of electronic devices are being widely used such as mobile communication terminals, smart phones, tablet personal computers (PCs), personal digital assistants (PDAs), electronic organizers, notebook computers, wearable devices, etc. The electronic devices are coming to a mobile convergence level encompassing even functions of other devices. For example, the electronic devices can provide a phone call function such as voice telephony, video telephony, etc., a message transmission/reception function such as a short message service (SMS)/multimedia message service (MIMS), an electronic mail (e-mail), etc., an electronic organizer function, a photographing function, a broadcast play function, a video play function, a music play function, an Internet function, a messenger function, a game function, a social networking service (SNS) function, etc.

The electronic devices are being designed in various forms. One of these forms can be a flexible device and/or a wearable device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a flexible electronic device can be developed into a wearable electronic device. The wearable electronic device refers to an electronic device that a user can wear. Accordingly, the flexible electronic device can be transformed depending on a wearing state of the flexible electronic device.

Another aspect of the present disclosure is to provide an apparatus and method for displaying screen information in an electronic device of a wearing state.

Another aspect of the present disclosure is to provide an apparatus and method for determining a user visible region and setting a display region in a worn electronic device.

Another aspect of the present disclosure is to provide an apparatus and method for setting a main display region in accordance with a position of a fastening part of a worn electronic device and a wearing direction of the worn electronic device.

Another aspect of the present disclosure is to provide an electronic device can provide an apparatus and method capable of setting a main display region and a sub display region in accordance with a fastening part and a wearing direction, and controlling a display brightness of the sub display region less than a display brightness of the main display region, to save a power source in the worn electronic device.

In accordance with another aspect of the present disclosure, an electronic device can provide an apparatus and method capable of setting a main display region and a sub display region in accordance with a fastening part and a wearing direction, and adjusting the display regions in accordance with an interaction in the worn electronic device.

In accordance with another aspect of the present disclosure, an electronic device is provided. The electronic device includes a flexible display, and a processor operatively coupled to the display. The processor is configured to detect a position of a fastening part of the electronic device, set a display region of the display, and display screen information in the display region.

In accordance with another aspect of the present disclosure, a method for operating in an electronic device having a flexible display is provided. The method includes detecting wearing of the electronic device, detecting a position of a fastening part of the electronic device, setting a display region of the display, and displaying screen information in the display region.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device according to an embodiment of the present disclosure;

FIGS. 2A and 2B are diagrams explaining an example of transforming a flexible electronic device according to various embodiments of the present disclosure;

FIGS. 3A, 3B, 3C, 3D, 3E, 3F, 3G and 3H are diagrams for explaining a structure of a flexible electronic device according to various embodiments of the present disclosure;

FIGS. 4A, 4B, and 4C are diagrams for explaining an operation according to a state of a flexible electronic device according to various embodiments of the present disclosure;

FIGS. 5A and 5B are diagrams for explaining a method of setting a display region in a wearing state of an electronic device according to various embodiments of the present disclosure;

FIG. 6 is a flowchart illustrating a method of setting a display region in accordance with a wearing state of an electronic device according to an embodiment of the present disclosure;

FIG. 7 is a flowchart illustrating a method of setting a display region in accordance with a wearing state and wearing-release state of an electronic device according to an embodiment of the present disclosure;

FIG. 8 is a flowchart illustrating a method of controlling a display region in accordance with a user's interaction in an electronic device according to an embodiment of the present disclosure;

FIG. 9 is a flowchart illustrating an operation of processing information of main and sub display regions in an electronic device according to an embodiment of the present disclosure;

FIG. 10 is a diagram for explaining an example of displaying information in main and sub display regions in an electronic device of a wearing state according to an embodiment of the present disclosure;

FIG. 11 is a flowchart illustrating an example of executing a viewer application in an electronic device based on a wearing state according to an embodiment of the present disclosure;

FIG. 12 is a diagram illustrating an example of execution of a viewer application in an electronic device that is worn on a posterior surface according to an embodiment of the present disclosure;

FIG. 13 is a diagram illustrating an example of execution of a viewer application in an electronic device that is worn on an anterior surface according to an embodiment of the present disclosure;

FIG. 14 is a flowchart illustrating a method of linking and displaying main information and sub information in an electronic device according to an embodiment of the present disclosure;

FIGS. 15A and 15B are diagrams illustrating an example of processing a map application while wearing an electronic device according to various embodiments of the present disclosure;

FIG. 16 is a flowchart illustrating a method of linking and displaying main information and sub information in an electronic device according to an embodiment of the present disclosure;

FIG. 17 is a diagram illustrating an example of processing a call processing application while wearing an electronic device according to an embodiment of the present disclosure;

FIG. 18 is a flowchart illustrating a method of performing a task switching operation in an electronic device according to an embodiment of the present disclosure;

FIGS. 19A, 19B, and 19C are diagrams illustrating an example of task switching operations of FIG. 18 according to various embodiments of the present disclosure;

FIG. 20 is a flowchart illustrating a method of extending a main display region in an electronic device according to an embodiment of the present disclosure;

FIGS. 21A and 21B are diagrams illustrating examples of extending a main display region in an electronic device according to various embodiments of the present disclosure; and

FIGS. 22A and 22B are diagrams illustrating examples of setting a display region while wearing an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, an expression such as “A or B,” “at least one of A and B,” or “one or more of A and B” may include all possible combinations of the listed items. Expressions such as “first,” “second,” “primarily,” or “secondary,” as used herein, may represent various elements regardless of order and/or importance and do not limit corresponding elements. The expressions may be used for distinguishing one element from another element. When it is described that an element (such as a first element) is “(operatively or communicatively) coupled” to or “connected” to another element (such as a second element), the element can be directly connected to the other element or can be connected through another element (such as a third element).

An expression “configured to (or set)” used in the present disclosure may be used interchangeably with, for example, “suitable for,” “having the capacity to,” “designed to,” “adapted to,” “made to,” or “capable of” according to a situation. A term “configured to (or set)” does not only mean “specifically designed to” by hardware. Alternatively, in some situations, the expression “apparatus configured to” may mean that the apparatus “can” operate together with another apparatus or component. For example, a phrase “a processor configured (or set) to perform A, B, and C” may be a generic-purpose processor (such as a central processing unit (CPU) or an application processor) that can perform a corresponding operation by executing at least one software program stored at an exclusive processor (such as an embedded processor) for performing a corresponding operation or at a memory device.

An electronic device according to embodiments of the present disclosure, may be embodied as, for example, at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), an Moving Picture Experts Group phase 1 or phase 2 (MPEG-1 or MPEG-2) audio layer 3 (MP3) player, a medical equipment, a camera, and a wearable device. The wearable device can include at least one of an accessory type (e.g., a watch, a ring, a bracelet, an ankle bracelet, a necklace, glasses, a contact lens, or a head-mounted-device (HMD)), a fabric or clothing embedded type (e.g., electronic garments), a body attachable type (e.g., a skin pad or a tattoo), and an implantable circuit. The electronic device may be embodied as at least one of, for example, a television, a digital versatile disc (DVD) player, an audio device, a refrigerator, an air-conditioner, a cleaner, an oven, a microwave oven, a washing machine, an air cleaner, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, and an electronic frame.

In another embodiment, the electronic device may be embodied as at least one of various medical devices (such as, various portable medical measuring devices (a blood sugar measuring device, a heartbeat measuring device, a blood pressure measuring device, or a body temperature measuring device), a magnetic resonance angiography (MRA) device, a magnetic resonance imaging (MRI) device, a computed tomography (CT) device, a scanning machine, and an ultrasonic wave device), a navigation device, a global navigation satellite system (GNSS), an event data recorder (EDR), a flight data recorder (FDR), a vehicle infotainment device, electronic equipment for a ship (such as, a navigation device for ship and gyro compass), avionics, a security device, a head unit for a vehicle, an industrial or home robot, a drone, an automated teller machine (ATM) of a financial institution, a point of sales (POS) device of a store, and an Internet of things (IoT) device (e.g., a light bulb, various sensors, a sprinkler device, a fire alarm, a thermostat, a street light, a toaster, sports equipment, a hot water tank, a heater, and a boiler). According to an embodiment, the electronic device may be embodied as at least one of a portion of furniture, building/construction or vehicle, an electronic board, an electronic signature receiving device, a projector, and various measuring devices (e.g., water supply, electricity, gas, or electric wave measuring device). An electronic device, according to an embodiment, can be a flexible electronic device or a combination of two or more of the foregoing various devices. An electronic device, according to an embodiment of the present disclosure, is not limited to the foregoing devices may be embodied as a newly developed electronic device. The term “user”, as used herein, can refer to a person using an electronic device or a device using an electronic device (e.g., an artificial intelligence electronic device).

In various embodiments of the present disclosure, the electronic device is a flexible electronic device, and can be a wearable electronic device.

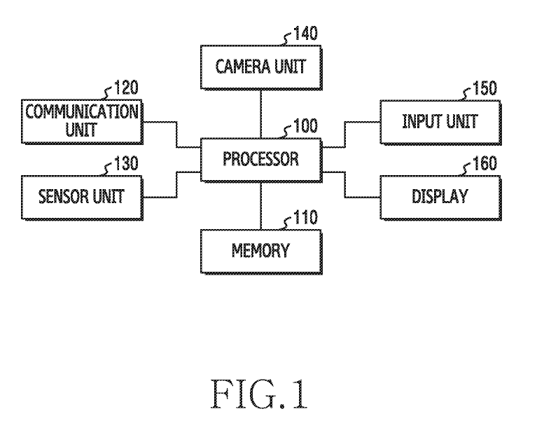

FIG. 1 is a diagram illustrating an electronic device according to an embodiment of the present disclosure.

Referring to FIG. 1, the electronic device can be a wearable electronic device and/or a flexible electronic device. The electronic device can include a processor 100, a memory 110, a communication unit 120, a sensor unit 130, a camera unit 140, an input unit 150, and/or a display 160. In some embodiment, the electronic device can omit at least one of the constituent elements or additionally have another constituent element. In the electronic device of FIG. 1, the input unit 150 and the display 160 can be a one-piece touch screen (or touch screen sensor) as a flexible device. In the electronic device of FIG. 1, all or some constituent elements of the processor 100, the memory 110, the communication unit 120, the sensor unit 130 and/or the camera unit 140 can be configured to have one or more flexible printed circuit boards (PCB). The flexible printed circuit board can be curved, bent, rolled, or folded together with the flexible touch screen sensor. In the following description, the term bending may include a curving, a bending, a rolling and a folding shape.

The processor 100 can include one or more of a CPU, an application processor (AP), or a communication processor (CP). The processor 100 can, for example, execute operation or data processing according to control and/or application execution of at least one another constituent element of the electronic device.

The processor 100 according to various embodiments of the present disclosure can set a display region of the display 160 in accordance with wearing or non-wearing of the electronic device. For example, when the processor 100 senses the wearing of the electronic device, the processor 100 can analyze a position (e.g., the posterior wrist surface, the anterior wrist surface, a radial border of the wrist between the anterior and posterior surfaces, etc.) of a fastening part of the electronic device and/or a wearing location of the electronic device, and set a partial region of the display 160 as a main display region, and set the remaining region of the display 160 as a sub display region. For example, the processor 100 can set a user visible region as the main display region, and set the remaining region excluding the visible region, as the sub display region. If an interaction (i.e., extension interaction) for extension of the main display region is recognized, the processor 100 can extend the main display region towards an upper side or a lower side of the main display region. At wearing release, the processor 100 can set the whole region of the display 160, as a display region. The processor 100 is described below in more detail with reference to the accompanying drawings.

The memory 110 can include a volatile and/or non-volatile memory. The memory 110 can store a command or data related to at least one another constituent element of the electronic device. The memory 110 can store a software and/or program. The program can, for example, include a kernel, a middleware, an application programming interface (API), an application program (or “application”), etc. At least some of the kernel, the middleware, or the API can be called an operating system (OS).

The communication unit 120 can include a wireless communication module and a wired communication module. The wireless communication module can include a cellular communication module and a short-range communication module.

The cellular communication module can use at least one of long term evolution (LTE), LTE-advanced (LTE-A), code division multiple access (CDMA), wideband CDMA (WCDMA), universal mobile telecommunications system (UMTS), wireless broadband (WiBro), global system for mobile communications (GSM), etc. The cellular communication module can, for example, provide voice telephony, video telephony, a text service, an Internet service, etc., through a telecommunication network. According to an embodiment, the cellular communication module can perform the distinction and authentication of the electronic device within a telecommunication network, using a subscriber identification module (e.g., subscriber identification module (SIM) card). According to an embodiment, the cellular communication module can perform at least some functions among functions that the processor 100 can provide. According to an embodiment, the cellular communication module can include a CP.

The short-range communication module can include wireless fidelity (Wi-Fi), Bluetooth (BT), near field communication (NFC), or magnetic secure transmission (MST). Also, the wireless communication module can include a position measurement module such as a global navigation satellite system (GNSS), a global positioning system (GPS), etc. The MST can generate a pulse in accordance with transmission data, using an electromagnetic signal. The pulse can generate a magnetic field signal. The electronic device can transmit the magnetic field signal to a POS. The POS can restore data by detecting the magnetic field signal through an MST reader and converting the detected magnetic field signal into an electrical signal. In accordance with a use area, a bandwidth, etc., the GNSS can, for example, include at least one of a GPS, a Global navigation satellite system (Glonass), a Beidou navigation satellite system (hereinafter, referred to as “Beidou”), Galileo, or the European global satellite-based navigation system. Below, the term “GPS” can be used interchangeably with the “GNSS.”

The wired communication module can, for example, include at least one of a universal serial bus (USB), a high definition multimedia interface (HDMI), a recommended standard-232 (RS-232), a plain old telephone service (POTS), etc.

The sensor unit 130 can meter a physical quantity or sense a working state of the electronic device, and convert metered or sensed information into an electrical signal. The sensor unit 130 can include at least one of a gesture sensor, a gyro sensor, a barometer, a magnetic sensor, an acceleration sensor, a grip sensor, a proximity sensor, a color sensor (e.g., a red, green, blue (RGB) sensor), a medical sensor, a temperature/humidity sensor, an illuminance sensor, an ultraviolet (UV) sensor, or a flexible sensor sensing the bending of the electronic device.

In various embodiments of the present disclosure, in case where the display 160 is a flexible display, the sensor unit 130 can include a bending sensor for sensing the bending (or flexing) of the electronic device. The bending sensor can be installed in a wearing state providing device of the electronic device or in adjacent to the wearing state providing device. In various embodiments of the present disclosure, in case where the electronic device is a wearable electronic device, the sensor unit 130 can include a fastening sensor capable of recognizing the wearing of the wearable electronic device. The fastening sensor can be installed in a fastening part of the wearable electronic device. The fastening sensor can be a magnetic sensor. The magnetic sensor can arrange magnets of mutually different polarities at both ends of the fastening part, and senses a magnetic field that is varied in accordance with the fastening or non-fastening of the fastening part, thereby sensing the wearing or non-wearing of the electronic device. Also, the fastening sensor can be a proximity sensor. The proximity sensor is located in the fastening part and senses the proximity or non-proximity of the fastening part. In various embodiments of the present disclosure, the medical sensor of the sensor unit 130 can include a heart rate monitoring (HRM) sensor and/or a UV light sensor. The HRM sensor can be installed in a rear surface (for example, a surface contacting with the wrist of a user) of the electronic device. The UV sensor can be installed in a front surface (for example, a position capable of sensing external light such as solar light, etc.) of the electronic device.

Additionally or alternatively, the sensor unit 130 can further include a control circuit for controlling at least one or more sensors belonging therein. In some embodiment, the electronic device can further include a processor configured to control the sensor unit 130, as a part of the processor 100 or independently. So, the electronic device can use the additional processor, to control the sensor unit 130 while the processor 100 is in a sleep state.

The camera unit 140 is, for example, a device able to take a still picture and a moving picture. According to one embodiment, the camera unit 140 can include one or more image sensors (e.g., a front sensor or a rear sensor), a lens, an image signal processor (ISP), or a flash (e.g., a light emitting diode (LED), a xenon lamp, etc.).

The input unit 150 can include a touch panel, a (digital) pen sensor, a key or at least one of ultrasonic input units. The touch panel can employ at least one scheme among a capacitive overlay scheme, a pressure sensitive scheme, an infrared beam scheme, or an ultrasonic scheme. Also, the touch panel can further include a control circuit as well. The touch panel can further include a tactile layer, to provide a tactile response to a user. The (digital) pen sensor can be a part of the touch panel or can include a separate sheet for recognition. The key can, for example, include a physical button, an optical key, or a keypad. The ultrasonic input unit can sense an ultrasonic wave generated in an input tool, through a microphone, and check data corresponding to the sensed ultrasonic wave. The input unit 150 according to various embodiments of the present disclosure can be a touch panel. And, the touch panel can include a pressure sensor function.

The display 160 can, for example, include a liquid crystal display (LCD), a light emitting diode (LED) display, an organic light emitting diode (OLED) display, or a micro electro mechanical systems (MEMS) display, or an electronic paper display. The display 160 can display various screens (e.g., a text, an image, a video, an icon, a symbol, etc.) for a user.

The input unit 150 and the display 160 can be each constructed as a one-piece touch screen. The touch screen can display a screen under the control of the processor 100, and detect a touch, gesture, proximity, or hovering input that uses an electronic pen or a part of the user's body.

In various embodiments of the present disclosure, if the electronic device is a wearable electronic device, the input unit 150 and the display 160 can be flexible devices.

In various embodiments of the present disclosure described below, the wearable electronic device can be included in the scope of the electronic device. An operation of linking between electronic devices can work even in the wearable electronic device and various electronic devices. For example, in various embodiments of the present disclosure, the wearable electronic device can include all devices that use one or more of various processors such as an AP, a CP, a graphic processing unit (GPU), a CPU, etc. The devices can be all information communication equipment supporting a function according to various embodiments of the present disclosure, multimedia equipment, wearable devices, and an applied equipment thereof.

The flexible electronic device can be a bendable electronic device. And, the wearable electronic device can mean an electronic device that a user is possible to wear. The electronic device according to various embodiments of the present disclosure can be a flexible and wearable electronic device. In the following description, the flexible electronic device and the wearable electronic device will be used as the same meaning.

Also, in a state where the electronic device is coupled with another electronic device, the electronic device according to an embodiment of the present disclosure can perform a function corresponding to a wearable device in association between another electronic device and the wearable device, in accordance with the coupling or non-coupling of the wearable device.

The processor 100 can control the execution of an application, using the memory 110. The application (e.g., application program) can, for example, include one or more applications capable of performing functions of a home, a dialer, a short message service (SMS)/multimedia message service (MMS), an instant message (IM), a browser, a camera, an alarm, a contact, a voice dial, an electronic mail (e-mail), a calendar, a media player, an album, a watch, or health care (e.g., measuring a quantity of motion, a blood sugar, etc.), environment information provision (e.g., providing air pressure, humidity, temperature information, etc.), etc.

According to an embodiment, the application can include an application (hereinafter, referred to as an “information exchange application”) supporting information exchange between the electronic device and an external electronic device (i.e., another electronic device). The information exchange application can, for example, include a notification relay application for relaying specific information to the external electronic device, or a device management application for managing the external electronic device.

For example, the notification relay application can include a function of relaying notification information that is generated in another application (e.g., an SMS/MMS application, an e-mail application, a health care application, an environment information application, etc.) of the electronic device, to the external electronic device. Also, the notification relay application can, for example, receive notification information from the external electronic device, and provide the received notification information to a user.

The device management application can, for example, manage (e.g., install, delete, or update) at least one function of the external electronic device communicating with the electronic device (e.g., turn-on/turn-off of the external electronic device itself (or partial constituent component thereof) or adjustment of a brightness (or resolution) of a display), an application working in the external electronic device, or a service (e.g., a telephony service, a message service, etc.) provided by the external electronic device.

According to an embodiment, the application can include an application (e.g., a health care application, etc. of a mobile medical instrument) that is designated according to an attribute of an external electronic device. According to an embodiment, the application can include an application received from the external electronic device. According to an embodiment, the application can include a preloaded application, or a third party application downloadable from a server.

In various embodiments of the present disclosure described below, a hardware access method is explained as an example. However, since the various embodiments of the present disclosure include a technology using all of hardware and software, the various embodiments of the present disclosure does not exclude a software based access method.

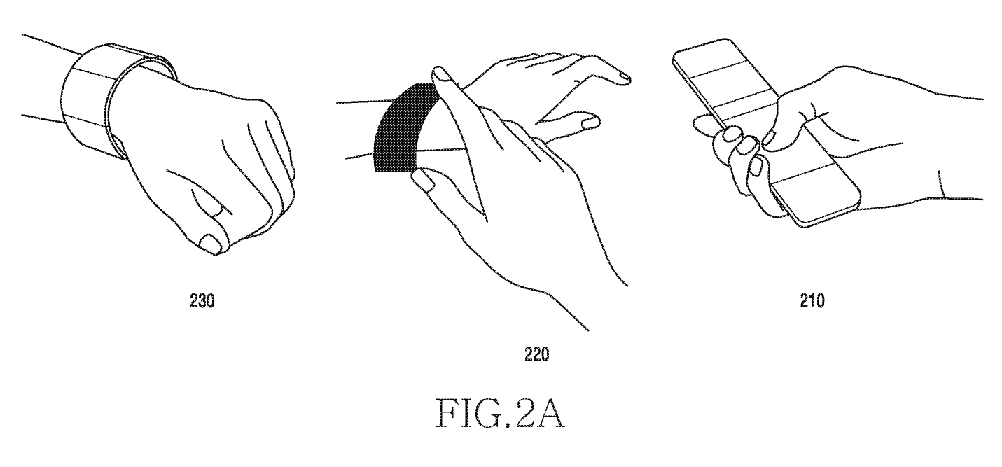

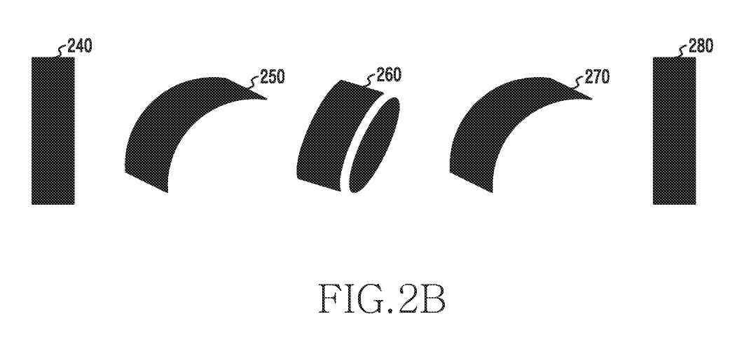

FIGS. 2A and 2B are diagrams illustrating an example of transforming a flexible electronic device according to various embodiments of the present disclosure.

Referring to FIG. 2A, in a non-wearing state 210 of the electronic device, the electronic device according to various embodiments of the present disclosure can be used as a general portable terminal device. And, in a wearing state 230 of the electronic device, the electronic device can be used as a wearable electronic device. At this time, when a user transforms the non-wearing state 210 to the wearing state 230 or transforms the wearing state 230 to the non-wearing state 210, the user performs a motion of attaching the electronic device to the user's body (for example, wrist) or detaching the electronic device from the user's body, as denoted by reference numeral 220. Particularly, when the user transforms the non-wearing state 210 to the wearing state 230, the user can perform a motion of bending and attaching the electronic device to the body, as denoted by reference numeral 220.

The flexible electronic device according to various embodiments of the present disclosure can be transformed into the wearing state 230/non-wearing state 210. When the transformation is sensed (for example, when the electronic device is bent or unbent), the flexible electronic device can determine a situation of the electronic device and convert into a function and/or user interface (UI) suitable to a transformed state (e.g., wearing state or non-wearing state). For example, in a state in which transformation from the non-wearing state 210 to the wearing state 230 is under progress as denoted by reference numeral 220, the electronic device can activate a related function and/or UI previously such that an operation of the non-wearing state 210 can be executed smoothly (or quickly) in the wearing state 230.

Referring to FIG. 2B, the flexible electronic device can be in a non-wearing state, a wearing state, a transforming state, etc. As illustrated in FIG. 2B, the flexible electronic device can be transformed from a non-wearing state 240 to a wearing state 260 via a transforming state 250. Also, the flexible electronic device can be transformed from the wearing state 260 to a non-wearing state 280 via a transforming state 270. The flexible electronic device can perform a set function in the wearing state and the non-wearing state. The flexible electronic device according to various embodiments of the present disclosure can activate a corresponding device and/or UI in the transforming states 250 and/or 270, such that the flexible electronic device can perform a function (or operation) suitable to a transformed state.

The electronic device according to various embodiments of the present disclosure can be, as illustrated in FIGS. 2A and 2B, an electronic device that is both flexible and wearable.

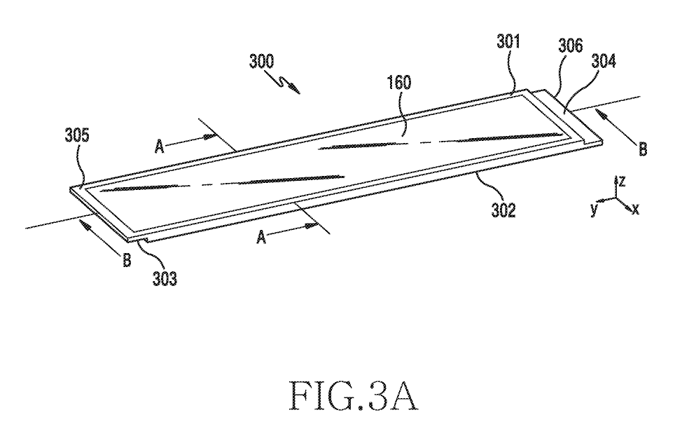

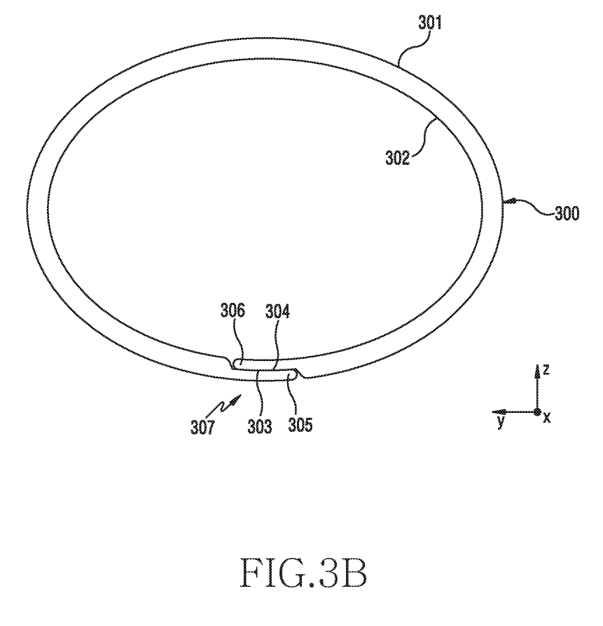

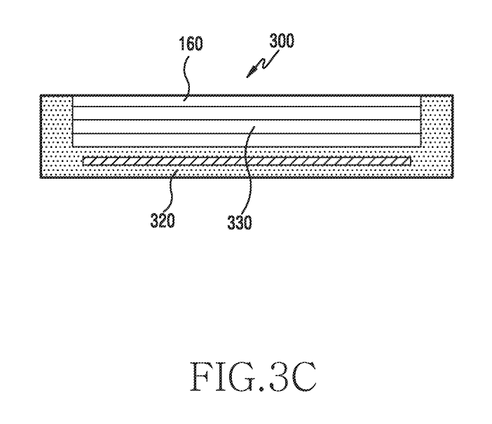

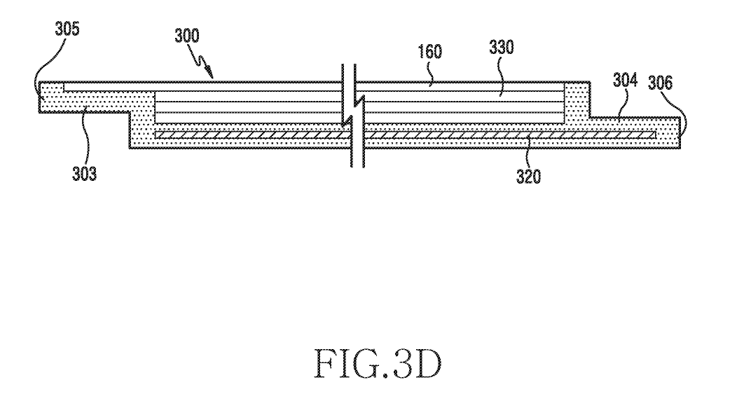

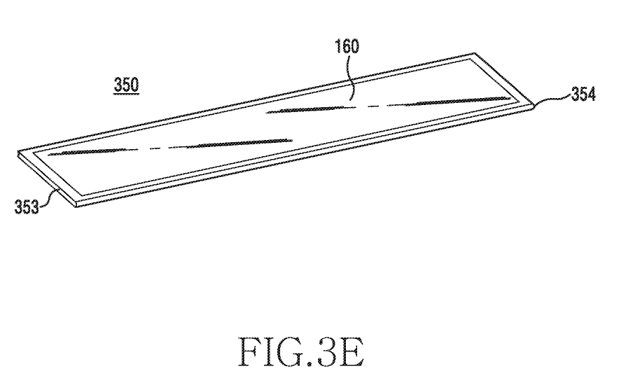

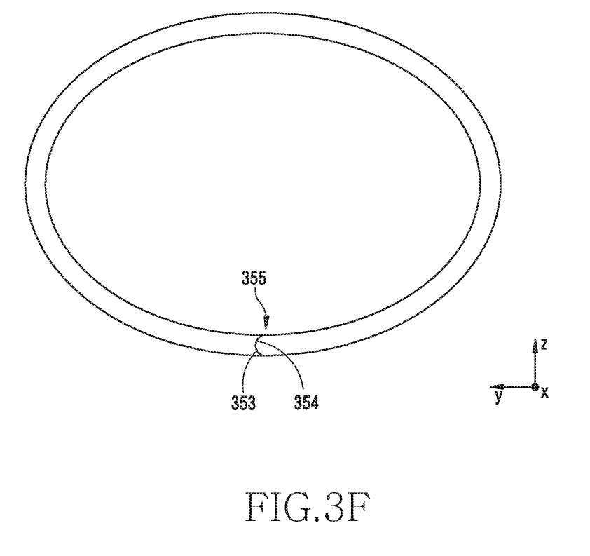

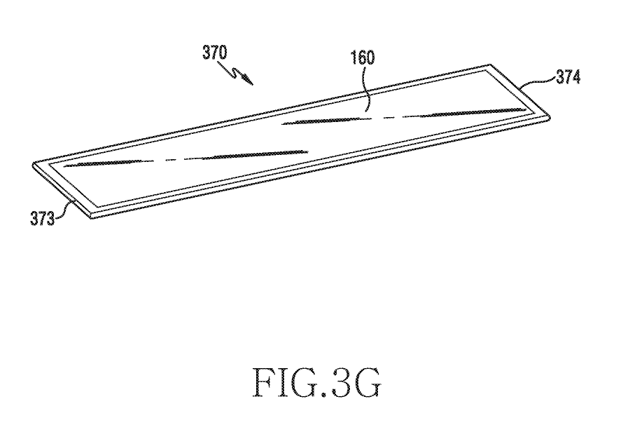

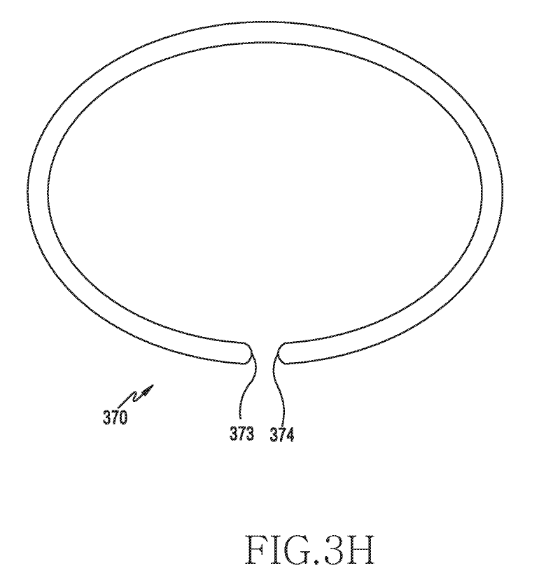

FIGS. 3A, 3B, 3C, 3D, 3E, 3F, 3G and 3H are diagrams for explaining a structure of a flexible electronic device according to various embodiments of the present disclosure.

FIG. 3A is a perspective view illustrating a flexible electronic device of a flat state according to an embodiment of the present disclosure. FIG. 3B is a front view illustrating a flexible electronic device of a state of being worn on the wrist according to an embodiment of the present disclosure.

Referring to FIGS. 3A and 3B, the flexible electronic device according to various embodiments is a wearable device and can be, for example, an electronic device capable of being worn on a human-body specific part such as the wrist, etc. FIG. 3A illustrates a 1st position state of the flexible electronic device. And, FIG. 3B illustrates a 2nd position state of the flexible electronic device. The 1st position state represents a state in which the flexible electronic device is approximately flat. The 2nd position state represents a state in which the flexible electronic device is worn on the wrist, etc. by a force applied to the flexible electronic device. A power source providing the above-mentioned force will be described later.

The flexible electronic device according to various embodiments can include one body 300. The body 300 according to various embodiments is approximately of a band shape extending long in one direction. The body 300 can include a 1st surface 301, and a 2nd surface 302 that is in a direction opposite to the 1st surface 301. The 1st surface 301, an outer surface of the flexible electronic device, can be a display region. And, the 2nd surface 302 can be an inner surface of the flexible electronic device, for example, a wearing surface contacting with the human skin. The 1st surface 301 can be a top surface of the flexible electronic device. And, the 2nd surface 302 can be a bottom surface of the flexible electronic device.

The body 300 according to various embodiments, a body of the flexible electronic device, can be curved, bent, rolled, or folded. Accordingly, the flexible electronic device can be worn on the human body, for example, in such a manner that a watch is worn on the wrist. In addition, the body 300 according to various embodiments can have a wearing function of getting a user to wear the flexible electronic device on the wrist.

The display 160 can be arranged in the 1st surface 301 of the body 300 according to various embodiments. The display 160 can be a flexible display. Below, the display 160 is called the flexible display. The flexible display 160 can be curved, bent, or folded together with the body 300.

The flexible electronic device according to various embodiments can include the body 300, the flexible display 160, and/or a wearing state providing device 320 (shown in FIGS. 3C and 3D).

Though not illustrated in the drawing, a speaker, a microphone, a front camera and/or at least one sensor can be arranged in the remaining region, for example, in a bezel region excluding the display region that is in the 1st surface 301 of the body 300.

The flexible display 160 arranged in the 1st surface 301 of the flexible electronic device according to various embodiments can consist of a touch screen (or touch screen sensor) including a touch panel. The touch screen can be configured to occupy the majority of the front surface of the flexible electronic device.

A home button (not shown) can be provided in the body 300, or not provided. If the home button is pressed, a main home screen can be displayed on the flexible display 160. For example, a power/reset button, a volume button, one or more microphones, etc. can be arranged in a lateral edge part of the flexible electronic device according to various embodiments. Also, a connector can be formed in the other lateral surface of the flexible electronic device according to various embodiments. The connector can have a plurality of electrodes, and can be wiredly coupled with an external device. An earphone connection jack (not shown) can be arranged in a lateral surface of the flexible electronic device. An earphone can be inserted into the earphone connection jack.

The body 300 of the flexible electronic device according to various embodiments can be worn on the wrist by the wearing state providing device 320. For example, a bending case part of the body 300 can be made with flexible materials (for example, a thin steel spring).

The flexible display 160 according to various embodiments is made with flexible materials. So, the flexible display 160 can be flat, or be arranged to roll in a rolling type, or be arranged to be folded or bent.

The body 300 according to various embodiments can include a main board (not shown), and electronic components mounted on the main board. The main board (not shown) can be configured to have an articulated structure by a flexible circuit unit. The main board can include at least some of the elements of FIG. 1. Additionally, the body according to various embodiments can include a flexible battery (not shown).

The flexible electronic device according to various embodiments can include a fastening part 307. The fastening part 307 refers to a fastening structure formed at both ends of the body 300 or a part made with materials capable of providing a force (i.e., fastening force) of fastening the both ends of the body 300, such that a user can wear the flexible electronic device on the wrist. The fastening part 307 according to various embodiments can include a body 1st end part 305 and a body 2nd end part 306. The 1st end part 305 can denote the one end of the body 300. And, the 2nd end part 306 can denote the other end part that is in a direction opposite to the 1st end part 305.

The fastening part 307 according to various embodiments can be configured in various forms and materials. The fastening part 307 of FIG. 3B is of a ruggedness structure. The fastening part 307 can provide a fastening force, using the magnetism of magnetic materials. The 1st end part 305 according to various embodiments can have a 1st recess 303 provided in the 2nd surface 302. The 2nd end part 306 can have a 2nd recess 304 provided in the 1st surface 301. The 1st recess 303 and the 2nd recess 304 according to various embodiments can be constructed in groove shapes, respectively. And, the 1st recess 303 and the 2nd recess 304 can be constructed to have shapes stepped from the 2nd surface 302 and the 1st surface 301, respectively. For example, if the 1st end part 305 and the 2nd end part 306 are fastened to each other, the 1st recess 303 can be combined with at least a part of the 2nd end part 306. And, the 2nd recess 304 can be combined with at least a part of the 1st end part 305. For example, if the 1st end part 305 and the 2nd end part 306 are fastened to each other, the 1st recess 303 can house and combine with at least a part of the 2nd end part 306, and the 2nd recess 304 can house and combine with at least a part of the 1st end part 305. A thickness of the fastening part 307 according to various embodiments can be approximately the same as a thickness of other parts of the body 300 excluding the fastening part 307.

The fastening part 307 according to various embodiments can provide a fastening force, by means of magnetic materials of different polarities or by means of magnetic materials and metal materials. For example, if the 1st end part 305 includes N-polarity magnetic materials and the 2nd end part 306 includes S-polarity magnetic materials, in a state where the flexible electronic device is worn, a mutual attractive force can work on the 1st end part 305 and the 2nd end part 306, and provide a fastening force between the 1st end part 305 and the 2nd end part 306. For example, if the 1st end part 305 includes N-polarity/S-polarity magnetic materials and the 2nd end part 306 includes metal materials, in a state where the flexible electronic device is worn, the 1st end part 305 and the 2nd end part 306 can be fastened to each other by a magnetic force.

FIG. 3C is a cross section taken along line A-A of FIG. 3A according to an embodiment of the present disclosure. FIG. 3D is a cross section taken along line B-B of FIG. 3A according to an embodiment of the present disclosure.

Referring to FIGS. 3C and 3D, the flexible electronic device according to various embodiments can have the wearing state providing device 320 getting the body 300 worn on the wrist.

The wearing state providing device 320 according to various embodiments can work in a semiautomatic manner. For example, if a constant force is applied to the wearing state providing device 320 in a 1st position state of FIG. 3A, the flexible electronic device can be worn to wrap around the wrist in a 2nd position state of FIG. 3B. For instance, the wearing state providing device 320 according to various embodiments can include a thin plate made with metal materials. The wearing state providing device 320 holds an approximately flat state. But, if a user puts the flexible electronic device on the wrist and applies a constant force to the flexible electronic device in a direction of wrapping around the wrist, the wearing state providing device 320 can provide a force of bending the flexible electronic device in the direction of wrapping around the wrist. The body 300 is arranged to wrap around the wrist by the wearing state providing device 320, so the flexible electronic device can be worn on the wrist. The wearing state providing device 320 can have a constant curvature.

In the flexible electronic device worn on the wrist according to various embodiments, if the body 300 with the wearing state providing device 320 is detached from the wrist by a constant force applied, the body 300 can be restored to the flat state of FIG. 3A by a restoring force of the wearing state providing device 320.

Reference numeral 330 can denote a printed circuit board assembly (PCBA). The PCBA can be made with flexible materials, or can be configured to have an articulated structure.

A construction of the fastening part according to various embodiments is described below.

Referring to FIGS. 3E and 3F, the flexible electronic device according to various embodiments can include a body 350, and a fastening part 355 fastening a 1st end part 353 of the body 350 and a 2nd end part 354 thereof. The fastening part 355 according to various embodiments is of a ruggedness structure. And, the fastening part 355 can include a 1st fastening part formed in the 1st end part 353, and a 2nd fastening part formed in the 2nd end part 354. For example, the 1st fastening part can be formed to be dented, and the 2nd fastening part can be formed to be swollen. Inversely, the 1st fastening part can be formed to be swollen, and the 2nd fastening part can be formed to be dented.

The fastening part 355 according to various embodiments can provide a fastening force, by means of magnetic materials having different polarities or by means of magnetic materials and metal materials. For example, if the 1st end part 353 includes N-polarity magnetic materials and the 2nd end part 354 includes S-polarity magnetic materials, in a state where the flexible electronic device is worn, a mutual attractive force can work on the 1st end part 353 and the 2nd end part 354 and provide a fastening force between the 1st end part 353 and the 2nd end part 354. For example, if the 1st end part 353 includes N-polarity/S-polarity magnetic materials and the 2nd end part 354 includes metal materials, in a state where the flexible electronic device is worn, a mutual attractive force can work on the 1st end part 353 and the 2nd end part 354 and provide a fastening force between the 1st end part 353 and the 2nd end part 354.

Referring to FIGS. 3G and 3H, the flexible electronic device according to various embodiments can include a body 370, and a 1st end part 373 of the body 370 and a 2nd end part 374 thereof. The 1st end part 373 and the 2nd end part 374 are configured such that they do not get in contact with each other when the flexible electronic device according to various embodiments is worn. Thus, a fastening part may not be provided. The 1st end part 373 and the 2nd end part 374 according to various embodiments can be configured to be in proximity to each other. If the flexible electronic device according to various embodiments is worn, the body 370 is arranged to wrap around the wrist and thus, can be worn on the wrist.

The flexible electronic device according to various embodiments of the present disclosure can be implemented in various methods. FIGS. 3A to 3H have been described by way of an example in which the wearing state providing device 320 is made with flexible materials (for example, a thin steel spring). However, the flexible electronic device can be implemented to be bent along the user's human body line by providing a body consisting of a plurality of connecting members and hinges linking the connecting members, at a lower end of a flexible touch screen. In this case, a printed circuit board including the elements of FIG. 1 can be configured in the plurality of connecting members. According to another embodiment, the flexible electronic device can be implemented to be bent along the user's body structure by providing a body consisting of grooves and protrusions at a lower end of a flexible touch screen.

The description has been made by way of an example in which the fastening parts of the flexible electronic device according to various embodiments of the present disclosure are implemented as magnets. However, the fastening part of the flexible electronic device can be configured to have a hook or buckle form as well. Also, the fastening part of the flexible electronic device can be configured to have a link (for example, watch chain link) form as well. In the flexible electronic device according to various embodiments of the present disclosure, a fastening sensor can be installed in the fastening part or in a position adjacent to the fastening part.

The electronic device according to various embodiments can be a wearable flexible electronic device. And, in case where the electronic device senses the transformation of the electronic device to a non-wearing state or wearing state, the electronic device can check an operation of the electronic device when the electronic device is transformed, and previously activate a function and/or UI suitable to a transformed state. By doing so, when the transformation to the non-wearing state/wearing state is completed, the electronic device can continuously perform the checked operation by using the previously activated function and/or UI.

The electronic device of the non-wearing state can perform a general operation of the electronic device. In the non-wearing state, if the electronic device is bent, the electronic device can recognize the bending of the electronic device by the output of the input unit 150 and/or the sensor unit 130. If the electronic device recognizes the bending, the electronic device can activate a function and/or a UI for, after wearing, performing an operation of the electronic device that is being conducted in the non-wearing state. And, if recognizing the wearing of the electronic device, the electronic device can convert into an operation mode of the wearing state and execute an operation.

The bending of the electronic device can be recognized in various methods. When a user transforms the electronic device from the non-wearing state to the wearing state, the user can bend the electronic device and wear the electronic device on the user's body. For example, the user can touch up/down and hold the electronic device and apply a pressure to the electronic device, thereby bending the electronic device. And, the user can position the bent electronic device on the wrist and perform a fastening operation. Accordingly, if the user performs a motion of bending the electronic device, the electronic device can recognize a user's multi touch input (for example, an up/down touch input to the display and/or the fastening part), and can recognize a pressure of the user's bending motion. Also, the electronic device can recognize that the electronic device is located on the user's wrist as well. The electronic device can recognize the user's multi touch input through the input unit 150. The electronic device can sense a pressure applied to the electronic device by means of a pressure sensor configured integrally with the touch panel of the input unit 150 or a pressure sensor configured independently in the sensor unit 130. The electronic device can recognize the bending of the electronic device by means of a bending sensor configured independently in the sensor unit 130 (for example, a sensor installed in a bezel region of the electronic device and sensing the bending of the electronic device). The electronic device can recognize that the electronic device is located on the wrist by means of a medical sensor (for example, an HRM sensor) configured independently in the sensor unit 130.

When the electronic device according to various embodiments of the present disclosure recognizes the bending of the electronic device, the electronic device can activate sensors in order and decrease power consumption. That is, the electronic device can activate the sensors capable of sensing the bending at a time point of sensing a user's bending intention. First, if the processor 100 recognizes a multi touch through the touch panel of the input unit 150, the processor 100 activates the sensor sensing the bending. If the sensor sensing the bending outputs a bending sensing signal, the processor 100 can recognize the bending of the electronic device. At this time, the bending sensor can be a pressure sensor. Then, if the processor 100 recognizes a multi touch through the touch panel, the processor 100 can activate the pressure sensor, and can analyze a pressure strength of a multi touch position sensed by the pressure sensor. If the pressure strength is equal to or is greater than a set strength, the processor 100 can recognize this as the bending of the electronic device. Also, the sensor unit 130 can include a medical sensor. Then, if the processor 100 senses a multi touch through the touch panel, the processor 100 can activate the medical sensor. If the processor 100 receives a sensing signal according to a contact of the human body from the medical sensor, the processor 100 can recognize this as the bending of the electronic device. The medical sensor can be a heart rate monitoring sensor. Also, the sensor sensing the bending can include a pressure sensor and a medical sensor. Then, if the processor 100 recognizes a multi touch input through the touch panel, the processor 100 can activate the pressure sensor. If the pressure sensor senses a pressure equal to or greater than a set strength, the processor 100 can activate the medical sensor. If the medical sensor senses a contact of the human body, the processor 100 can recognize this as the bending of the electronic device.

When a user bends and wears the electronic device as above, the electronic device can execute a set application in accordance with a user's touch interaction. The electronic device according to various embodiments of the present disclosure can use all regions excluding the fastening part as the display 160. However, the electronic device of the wearing state 230 of FIG. 2A can have a limitation of a display region. For example, in the wearing state, the display 160 can have a visible display region and an invisible display region in accordance with a user wearing location.

The electronic device according to various embodiments of the present disclosure can divide a display region of the display 160 into a main display region and a sub display region in accordance with transformation (i.e., a wearing state/non-wearing state), and display the main display region and the sub display region. For example, in the wearing state, the electronic device can analyze a user wearing location and a position of the fastening part and determine a position of the main display region in accordance with the analysis result, and can set an extension direction of the main display region in accordance with a user's touch interaction and enhance a user convenience. Also, when driving the display 160, the electronic device can display the main display region brighter than the sub display region and decrease the power consumption of the electronic device. The electronic device according to various embodiments of the present disclosure can determine a current direction of the main display region dependent on the wearing location of the electronic device, and extend and set the main display region. Second, when main information and sub information of an application have relationship, the electronic device can link the main information displayed in the extended main display region and the sub information displayed in the sub display region. Third, if the electronic device is transformed from the wearing state to the non-wearing state, the electronic device can transform the display 160 into a flat state and then, can convert an information array displayed in the wearing state into an information array displayed in the non-wearing state.

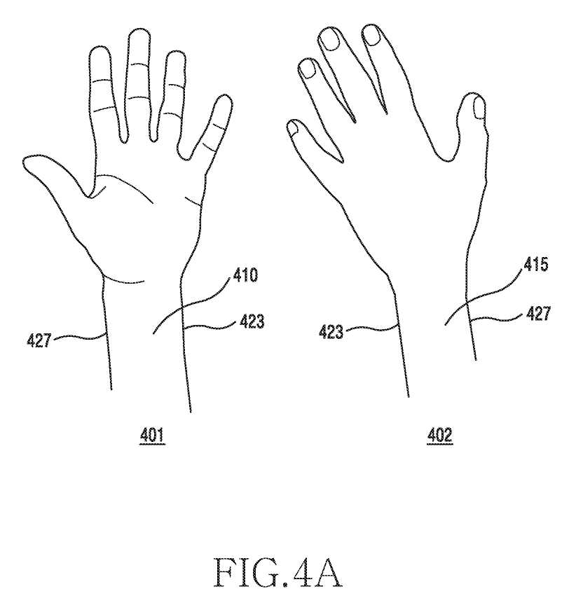

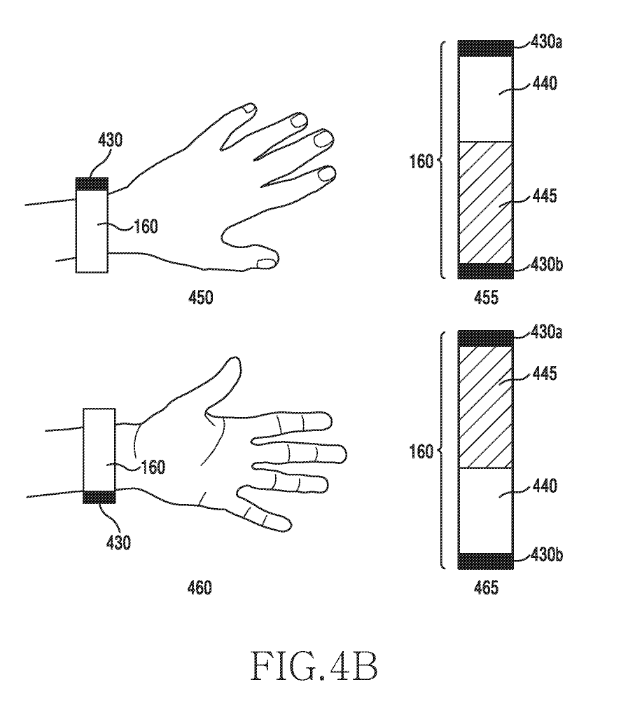

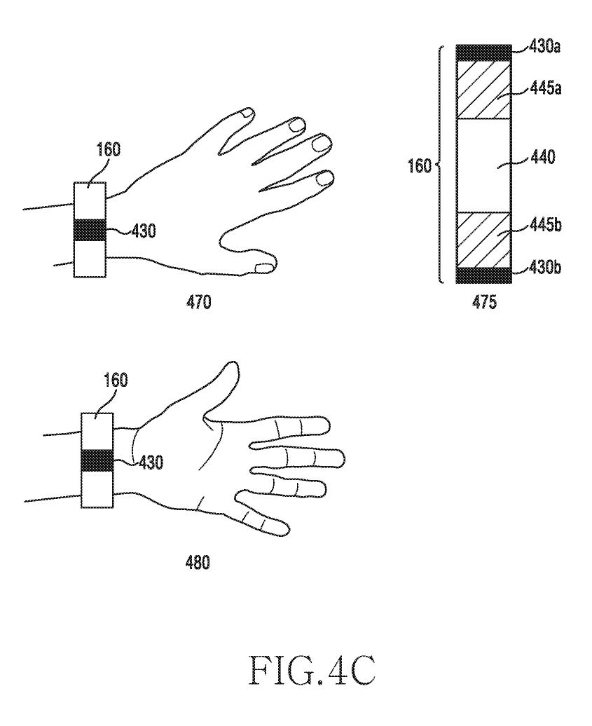

FIGS. 4A, 4B, and 4C are diagrams for explaining the relationship between a wearing state of an electronic device and a display according to various embodiments of the present disclosure. The electronic device can be worn on the user's right hand, and can be worn on the left hand as well. The following description will be made by way of an example in which the electronic device is worn on the left hand.

Referring to FIG. 4A, reference numerals 401 and 402 denote examples of a user's left hand. The electronic device can be worn on the user's wrist. Referring to FIG. 4A, reference numeral 410 is an anterior surface of the wrist, and reference numeral 415 is a posterior surface of the wrist. Also, reference numeral 423 is a radial border the wrist associated with adduction, and reference numeral 427 is a radial border associated with abduction of the wrist. When the user wears the electronic device, the user can see the fastening part and the display 160. In various embodiments of the present disclosure, although the electronic device can be fastened around the wrist, the active components of the electronic device can be worn on the wrist to contact the anterior surface 410 (i.e., inside) or posterior surface 415 (i.e., outside) of the wrist, or can be worn on the radial borders 423 and 427 of the wrist. A description will be made by way of an example in which the electronic device is worn on the anterior surface 410 or posterior surface 415 of the wrist, or is worn on the radial borders 423 and 427 of the wrist.

Referring to FIG. 4B, in the wearing state, the fastening part 430 can have forms denoted by reference numerals 450 and 460. And, in the non-wearing state, the fastening part 430 can have a spaced state denoted by 430a and 430b of reference numerals 455 and 465. If the fastening part 430 of the electronic device that is worn as denoted by reference numeral 450 is located on a radial border of the wrist and a user visible region is in the posterior surface, the electronic device can analyze the position of the fastening part 430 and a user wearing location (i.e., user visible region). Thereafter, the electronic device can set a main display region 440 in a 1st direction originating from the fastening part 430a as denoted by reference numeral 455. And, the electronic device can set a region arranged continuously between the main display region 440 and the fastening part 430b in the 1st direction originating from the main display region 440, as a sub display region 445. That is, if the electronic device is worn as denoted by reference numeral 450, the electronic device can set a region (i.e., user visible region) of the display 160 that is on the posterior surface as the main display region 440. And, the electronic device can set the remaining region of the display 160 that is on the anterior surface, as the sub display region 445. Here, the 1st direction can refer to a direction (for example, downward direction) originating from the fastening part 430a to the fastening part 430b.

Also, if the fastening part 430 of the electronic device that is worn as denoted by reference numeral 460 is located on the radial border of the wrist and the user visible region is in the palm direction, the electronic device can analyze the position of the fastening part 430 and a user wearing location (i.e., user visible region). Thereafter, the electronic device can set a main display region 440 in a 2nd direction originating from the fastening part 430b as denoted by reference numeral 465. And, the electronic device can set a region arranged continuously between the main display region 440 and the fastening part 430a in the 2nd direction originating from the main display region 440, as a sub display region 445. That is, if the electronic device is worn as denoted by reference numeral 460, the electronic device can set a region (i.e., user visible region) of the display 160 that is on the anterior surface, as the main display region 440. And, the electronic device can set the remaining region of the display 160 that is on the posterior surface as the sub display region 445. Here, the 2nd direction can refer to an upward direction going from the fastening part 430b to the fastening part 430a.

Referring to FIG. 4C, in the wearing state, the fastening part 430 can have forms denoted by reference numerals 470 and 480. And, in the non-wearing state, the fastening part 430 can have a spaced state denoted by 430a and 430b of reference numeral 475. If the fastening part 430 of the electronic device that is worn as denoted by reference numeral 470 is located in the back-of-hand direction of the wrist and the user visible region is in the palm direction, the electronic device can analyze the position of the fastening part 430 and a user wearing location (i.e., user visible region). Thereafter, as denoted by reference numeral 475, the electronic device can set the user visible region located opposite the fastening part 430, as a main display region 440. And, the electronic device can set regions between the main display region 440 and fastening parts 430a and 430b, as sub display regions 445a and 445b. That is, if the electronic device is worn as denoted by reference numeral 470, the electronic device can set a region (i.e., user visible region) of the display 160 on the anterior surface, as the main display region 440. And, the electronic device can set the remaining regions of the display 160 excluding the main display region 440, as the sub display regions 445a and 445b, respectively.

Also, if the fastening part 430 of the electronic device that is worn as denoted by reference numeral 480 is located in the palm direction of the wrist and the user visible region is in the back-of-hand direction, the electronic device can analyze the position of the fastening part 430 and the user wearing location (user visible region). Thereafter, as denoted by reference numeral 475, the electronic device can set the user visible region located opposite the fastening part 430, as the main display region 440. And, the electronic device can set regions between the main display region 440 and the fastening parts 430a and 430b, as the sub display regions 445a and 445b.

In case where the user wears the electronic device as denoted by reference numeral 470 or 480, the region of the display 160 that is on the anterior surface or posterior surface can be the user visible region. Accordingly, if the electronic device is worn such that the fastening part 430 is located on the anterior surface or the posterior surface, the electronic device can check a position of the fastening part 430. And, the electronic device can set a region of the display 160 (for example, a central display region of the display 160) located opposite of the fastening part 430, as the main display region 440. And, the electronic device can set regions of the display 160 excluding the main display region 440, as a 1st sub display region 445a and a 2nd sub display region 445b.

The following description is made by way of an example in which the electronic device according to various embodiments of the present disclosure is worn in a form denoted by reference numeral 450 or 460 of FIG. 4B.

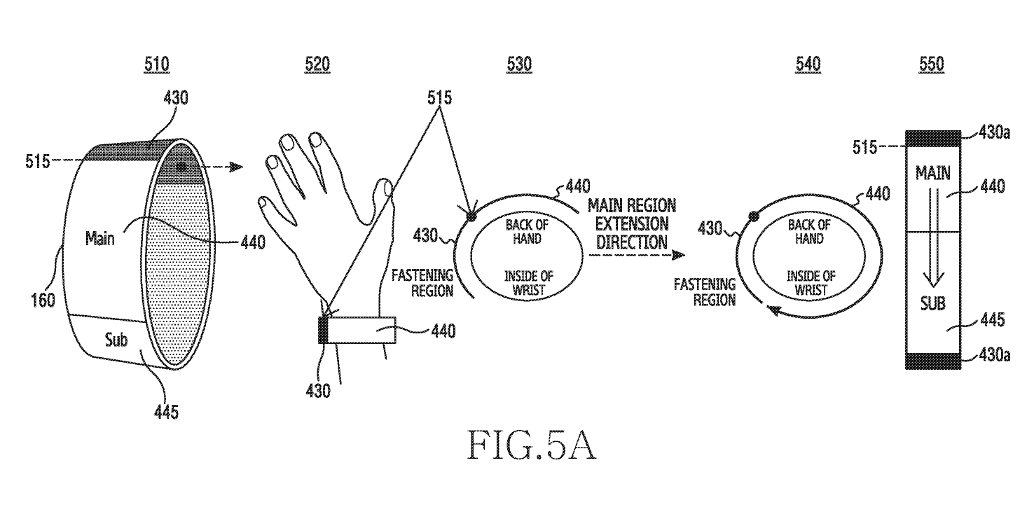

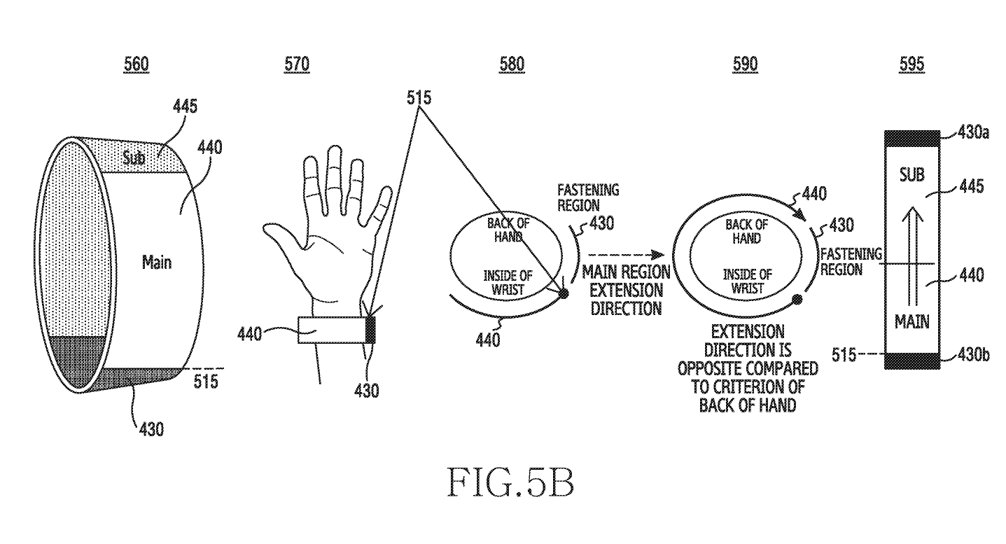

FIGS. 5A and 5B are diagrams for explaining a method of setting a display region in a wearing state of an electronic device according to various embodiments of the present disclosure.

The electronic device can sense that the electronic device has been worn using a fastening sensor of the sensor unit 130. At this time, the fastening part 430 of the electronic device can include all or some of hardware constituent elements of the electronic device illustrated in FIG. 1. And, the touch panel of the display 160 and input unit 150 can be located in a front surface of the electronic device. And, a part of the hardware construction of FIG. 1 can be located in a rear surface of the electronic device. Accordingly, the fastening part 430 can be larger in volume than a region of the electronic device where the display 160 is located. Accordingly, it can be desirable to wear the electronic device such that the fastening part 430 is located on the radial border of the wrist. Various embodiments of the present disclosure are described by way of an example in which the fastening part 430 of the electronic device is located and on the radial border of the wrist.

If the electronic device is worn on the wrist of a user, the electronic device can analyze a position of the fastening part 430 and a user wearing location. At this time, the user wearing location can be recognized through the sensor unit 130 and/or the camera unit 140. In a state where the electronic device is worn, the electronic device can recognize the user wearing location by analyzing outputs of a proximity sensor, a medical sensor, a gyro sensor, an acceleration sensor and/or the camera unit 140. For example, in a state where the electronic device is worn as denoted by reference numeral 520, the proximity sensor cannot recognize a distance with the user. But, in case where the fastening part 430 is located in the anterior surface as denoted by reference numeral 570 of FIG. 5B, the proximity sensor can recognize proximity or non-proximity with the user. Also, in a state where the electronic device is worn as denoted by reference numeral 520, the camera unit 140 cannot photograph the user. But, in case where the fastening part 430 is located in the anterior surface as denoted by reference numeral 570 of FIG. 5B, the camera unit 140 can photograph the user. Also, the medical sensor can output a medical sensing signal sensed on a posterior surface of the hand (i.e., the dorsal surface) of the user and a medical sensing signal sensed on the anterior surface of the wrist of a palm direction, as different values. Also, when the user rotates the wrist with wearing the electronic device, the gyro sensor and/or the acceleration sensor can recognize a rotation direction and/or a motion as mutually different values. If the electronic device is fastened, the electronic device can recognize the user wearing location (for example, an anterior surface or a posterior surface) of the electronic device, by analyzing at least one output value among outputs of the sensor unit 130 and/or the camera unit 140.

Referring to FIG. 5A, if the fastening part 430 is located on the radial border of the wrist and the wearing location is on the posterior surface as denoted by reference numeral 520, the electronic device can recognize that the electronic device has been worn in a form denoted by reference numeral 510. In this case, a user visible region can be on the posterior surface as illustrated by reference numeral 520. Then, the electronic device can set a boundary between the fastening part 430a and the display 160, as a reference line 515, and set a main display region 440 in a 1st direction (i.e., downward direction) from the reference line 515. That is, the electronic device can set the main display region 440 in the 1st direction originating from the reference line 515 as denoted by reference numeral 530. And, the electronic device can set a region of the display 160 ranging from a lower end edge of the main display region 440 to the fastening part 430b, as a sub display region 445. In a state where the main display region 440 and the sub display region 445 are set to the display 160 as denoted by reference numeral 530, if the user generates a check interaction (for example, swipe interaction), the electronic device can extend the main display region 440 in the 1st direction as denoted by reference numeral 540. That is, if an extension interaction is sensed, the electronic device can convert a part or all of the sub display region 445 into a main display region, for the sake of extension of the main display region 440, as illustrated by reference numeral 550.

Referring to FIG. 5B, if the fastening part 430 is located on the radial border of the wrist and the wearing location is on the anterior surface as denoted by reference numeral 570, the electronic device can recognize that the electronic device has been worn in a form denoted by reference numeral 560. In this case, the user visible region can be in the anterior surface as illustrated by reference numeral 570. Then, the electronic device can set a boundary between the fastening part 430b and the display 160 as a reference line 515, and set a main display region 440 in a 2nd direction (i.e., upward direction) from the reference line 515. That is, the electronic device can set the main display region 440 in the 2nd direction originating from the reference line 515 as denoted by reference numeral 580. And, the electronic device can set a region of the display 160 ranging from an upper end edge of the main display region 440 to the fastening part 430a, as a sub display region 445. In a state where the main display region 440 and the sub display region 445 are set to the display 160 as denoted by reference numeral 580, if the user generates a check interaction (for example, swipe interaction), the electronic device can extend the main display region 440 in the 2nd direction as denoted by reference numeral 590. That is, if an extension interaction is sensed, the electronic device can convert a part or all of the sub display region 445 into a main display region, for the sake of extension of the main display region 400, as illustrated by reference numeral 595.

An electronic device according to various embodiments of the present disclosure can include a flexible display, and a processor operatively coupled to the display. The processor can recognize a position of a fastening part of the worn electronic device, and set a display region of the display, and display screen information in the set display region.

The processor can detect a wearing of the electronic device, analyze the position of the fastening part and a wearing location, set a user visible region as a main display region, and set the remaining display region of the display as a sub display region. For example, in case where the electronic device is worn on the wrist, the fastening part can contact the anterior surface or the posterior surface of the wrist or can be on either radial border. Also, the wearing location can be a user visible region direction in a state where the user wears the electronic device. The visible region direction can be the anterior surface of the wrist or the posterior surface of the wrist.

If the position of the fastening part is on the radial border and the wearing location is on the anterior surface of the wrist, the processor can set the main display region in an upward direction originating from the fastening part, and can set the remaining region of the display as the sub display region. If an extension interaction is recognized, the processor can extend the main display region in the upward direction. Here, the upward direction can be a direction (for example, upward direction) going towards the display from the reference line that is a boundary between the fastening part of a lower end and the display in a state of unbending the electronic device.

If the position of the fastening part is on the radial border and the wearing location is on the posterior surface of the wrist, the processor can set the main display region in a downward direction originating from the fastening part, and set the remaining region of the display as the sub display region. If an extension interaction is recognized, the processor can extend the main display region in the downward direction. Here, the downward direction can be a direction (for example, downward direction) going towards the display from the reference line that is a boundary between the fastening part of an upper end and the display in a state of unbending the electronic device.

If the position of the fastening part is on either the anterior or posterior surface, the processor can set a display region of a position opposite the fastening part as the main display region, and set remaining display regions between the main display region and the fastening part as 1st and 2nd sub display regions. Here, the position opposite the fastening part can be a position facing the fastening part in a state where the electronic device is worn. For example, if the fastening part is located on the posterior surface, the main display region can be set to the anterior surface of the wrist. And, if the fastening part is located at the anterior surface of the wrist, the main display region can be set to the posterior surface.

The processor can display the main display region displaying main information, more brightly than the sub display region displaying sub information.

In a state where the electronic device is worn, if the main information and the sub information have relationship, the electronic device can link and display the main information and the sub information in the extended main display region. An information link criterion can distinguish if the main information and the sub (or sub depth) information are associated with each other by application in accordance with the lapse of time. An information display criterion can display the main information in the main display region, and can display a list of sub information of an upper depth (for example, past information compared to a current time point, future information compared to the current time point, etc.) than the main information, in the sub display region. In case where the electronic device links the main information and the sub information, if the electronic device selects the sub information, the electronic device can display detailed information of the selected sub information in the main display region.

If the main information and the sub information are viewer information, when an extension interaction is recognized, the processor can extend the main display region towards the sub display region, and display previous or next viewer information in the extended main display region. Here, the viewer information can be contents such as a text, an image, etc. When a viewer application is executed, the electronic device can recognize an interaction such as a swipe, as the extension interaction.

If the main information and the sub information are linked information, when an extension interaction is recognized, the processor can extend the main display region towards the sub display region, and display the sub information in the extended main display region. The electronic device can display the main information in the main display region, and display the sub information in the sub display region, and display the main information and the sub information by mutually different layers. And, if the sub information is selected, the electronic device can display the selected sub information in the extended main display region. At this time, the main information and the sub information can be overlaid and displayed as well. An application linking the main information and the sub information can be a map application, a call processing application, etc.

If the main information includes task switching information, when a selection of the task switching information is recognized, the processor can extend the main display region towards the sub display region, and display the selected task switching information in the extended main display region. If the task switching information displayed in the main display region is selected, the electronic device can extend the main display region, and display detailed information of the selected task switching information in the extended main display region. An application in which the main information includes the task switching information can be an application (e.g., an SMS, an SNS, an EMS, an MIMS, etc.) capable of inputting a text.

If the main information is external input information, when the external input information is recognized, the processor can extend the main display region towards the sub display region, and display the external input information in the extended main display region. An application inputting the external information can be a camera application, a contents downloading application, etc.

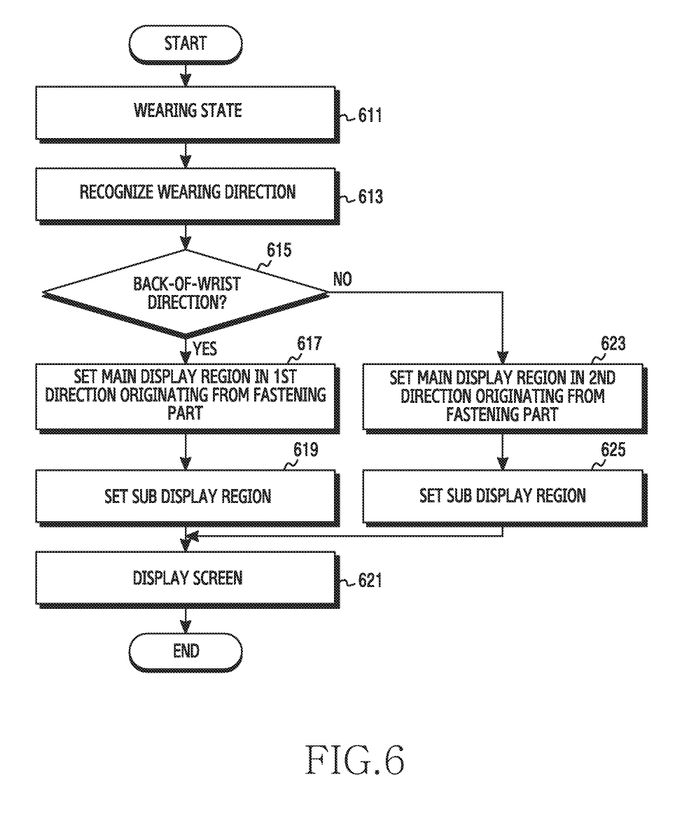

FIG. 6 is a flowchart illustrating a method of setting a display region in accordance with a wearing state of an electronic device according to an embodiment of the present disclosure.

Referring to FIG. 6, if the electronic device is worn, in operation 611, the electronic device can recognize a wearing state of the electronic device through the fastening sensor. If the wearing is recognized, in operation 613, the electronic device can analyze a position of the fastening part 430 of the worn electronic device and a wearing location of the worn electronic device. At this time, the fastening part 430 of the worn electronic device can be in a on the radial border of the wrist. The wearing location can be given as denoted by reference numeral 520 of FIG. 5A or reference numeral 570 of FIG. 5B. At this time, if the wearing location is on the anterior surface (i.e., back-of-hand direction, reference numeral 520 of FIG. 5A), in operation 615, the electronic device can recognize this. In operation 617, the electronic device can set a main display region in a 1st direction (for example, a downward direction) originating from the fastening part 430a, as denoted by reference numeral 530. Here, the main display region can be a user visible region, and a position of the main display region can be on the posterior surface. And, in operation 619, the electronic device can set a display region of the display 160 ranging from a lower end edge position of the main display region 440 to the fastening part 430b, as a sub display region. Thereafter, in operation 621, the electronic device can display screen information of a set application on the display 160. Also, in a state where the electronic device extends and displays the main display region, if a touch interaction going from the extended main display region to a reverse direction (for example, a 2nd direction (i.e., upward direction)) is recognized, the electronic device can initialize the extended main display region. For example, in a state where the electronic device extends the main display region as denoted by reference numeral 540, if a touch interaction (i.e., swipe or scroll) going in the reverse direction occurs, the electronic device can shrink the extended main display region and initialize to the main display region and the sub display region as denoted by reference numeral 530.

Also, if the wearing location of the worn electronic device is on the anterior surface (i.e., palm direction, reference numeral 570 of FIG. 5B), in operation 615, the electronic device can recognize this. And, in operation 623, the electronic device can set the main display region in a 2nd direction (for example, upward direction) originating from the fastening part 430b as denoted by reference numeral 580. Here, the main display region can be a user visible region, and a position of the main display region can be in the palm direction. And, in operation 625, the electronic device can set a display region of the display 160 ranging from an upper end edge position of the main display region 440 to the fastening part 430a, as a sub display region. Thereafter, in operation 621, the electronic device can display screen information of a set application on the display 160. Also, in a state where the electronic device extends and displays the main display region, if a touch interaction going from the extended main display region to a reverse direction (for example, 1st direction (i.e., downward direction)) is recognized, the electronic device can initialize the extended main display region. For example, in a state where the electronic device extends the main display region as denoted by reference numeral 590, if a touch interaction (i.e., swipe or scroll) going in the reverse direction occurs, the electronic device can shrink the extended main display region and initialize to the main display region and the sub display region as denoted by reference numeral 570.

At this time, a display screen of the main display region 440 can be displayed brighter than a display screen of the sub display region 445. That is, since the sub display region 445 may not be a user visible region, the electronic device can display the display screen of the sub display region 445 relatively dark, to decrease power consumption.

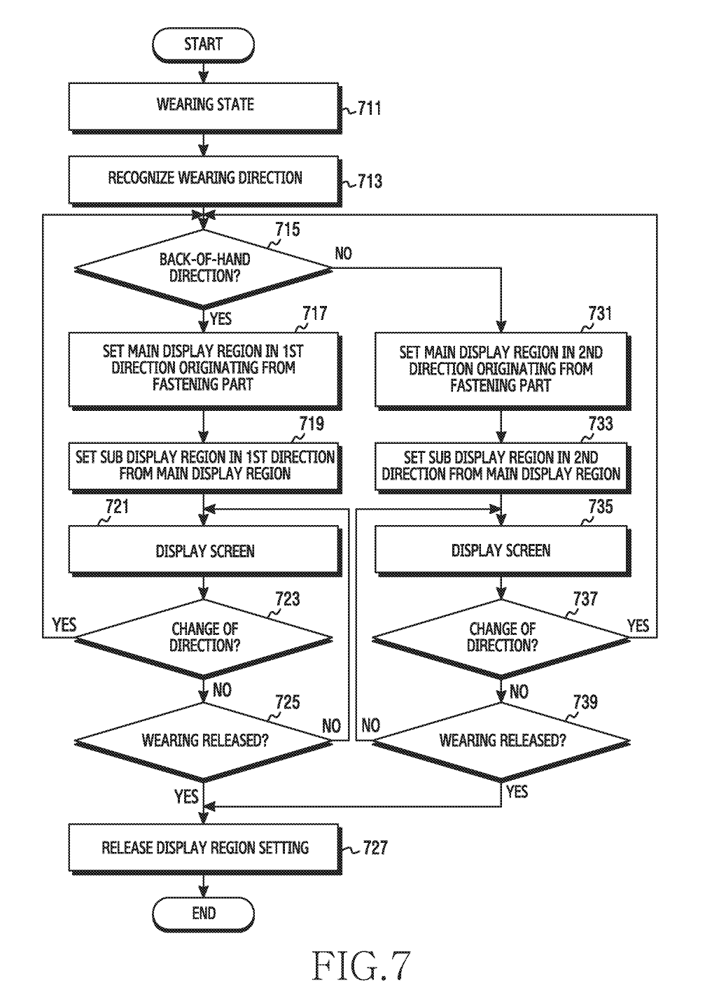

FIG. 7 is a flowchart illustrating a method of setting a display region in accordance with a wearing state and wearing-release state of an electronic device according to an embodiment of the present disclosure.

Referring to FIG. 7, if the electronic device is worn, in operation 711, the electronic device can recognize this. And, in operation 713, the electronic device can analyze a wearing location of the electronic device. At this time, the wearing location of the electronic device is on the posterior surface as denoted by reference numeral 520, and the anterior surface denoted by reference numeral 570, etc.

At this time, if the wearing location is on the posterior surface (i.e., back-of-hand direction), in operation 715, the electronic device can recognize this. And, in operation 717, the electronic device can set a main display region in a 1st direction (for example, downward direction) originating from the fastening part 430a as denoted by reference numeral 530. And, in operation 719, the electronic device can set a display region of the display 160 ranging from a lower end edge position of the main display region 440 to the fastening part 430b, as a sub display region. Thereafter, in operation 721, the electronic device can display screen information of a set application on the display 160.

If a wrist rotation occurs in a state where the main display region and the sub display region are set as denoted by reference numeral 510 of FIG. 5A, the electronic device can recognize the rotation of the electronic device by the gyro sensor, the acceleration sensor, etc. At this time, in operation 723, the electronic device can recognize that it is a change of direction of the electronic device and return to operation 715, if it is a state where a user does not extend the main display region 440 as denoted by reference numeral 530 (for example, if it is a state where the main display region and the sub display region are set as denoted by reference numeral 510). In this case, if a user wearing state is a state denoted by reference numeral 570 of FIG. 5B, the electronic device can reset a screen display region of the display 160 as denoted by reference numeral 560. However, if the main display region 440 is extended as denoted by reference numeral 540, although the electronic device recognizes the rotation of the wrist, the electronic device may not perform an operation of resetting the screen display region of the display 160. For example, in a state where the electronic device extends the main display region 440 in the 1st direction (i.e., downward direction), the user can rotate the wrist to check information of the extended main display region. That is, in case where the main display region 440 is extended, new display information can be displayed in the main display region 440, and previous information displayed in the main display region 440 can be moved and displayed in the extended main display region. In this case, the user can rotate the wrist to check the information of the extended main display region. Accordingly, if the electronic device senses the rotation of the wrist in a state where the main display region 440 is extended, the electronic device may not perform an operation of resetting the main/sub display regions.

Also, in a state where the electronic device is worn as denoted by reference numeral 520, if the user releases the wearing of the electronic device, in operation 725, the electronic device can recognize this. And, in operation 727, if the bending of the electronic device is released (i.e., if the display 160 is unbent as denoted by reference numeral 550), the electronic device can release the main and sub display regions that are set to the display 160, and display information of an application that is being executed. That is, if the wearing of the electronic device is released, the electronic device can make a screen display brightness of the whole region of the display 160 identical (for example, convert the screen display brightness of the whole region of the display 160 into a screen display brightness of the main display region) and display a screen. At this time, displayed information can be arranged and displayed in a direction (for example, the 1st direction) going from the fastening part 430a to the fastening part 430b.

Also, if the wearing location is on the anterior surface (i.e., palm direction), in operation 715, the electronic device can recognize this. And, in operation 731, the electronic device can set a main display region 440 in a 2nd direction (for example, upward direction) originating from the fastening part 430b as denoted by reference numeral 580. And, in operation 733, the electronic device can set a display region of the display 160 ranging from an upper end edge position of the main display region 440 to the fastening part 430a, as a sub display region. Thereafter, in operation 735, the electronic device can display screen information of a set application on the display 160.

If wrist rotation occurs in a state where the main display region and the sub display region are set as denoted by reference 560 of FIG. 5B, and it is a state where the user does not extend the main display region 440 (for example, if it is a state where the main display region and the sub display region are set as denoted by reference numeral 580), in operation 737, the electronic device can recognize that it is a change of direction of the electronic device and return to operation 715. That is, if the rotation of the wrist is recognized, and the user wearing state is a state where the main display region 440 and the sub display region 445 are set as denoted by reference numeral 560, the electronic device can reset a screen display region of the display 160. However, if it is a state where the main display region 440 is extended as denoted by reference numeral 590, although the electronic device recognizes the rotation of the wrist as above, the electronic device may not perform an operation of resetting the screen display region of the display 160.

Also, in a state where the electronic device is worn as denoted by reference numeral 570, if the user releases the wearing of the electronic device, in operation 739, the electronic device can recognize this. And, in operation 727, if the bending of the electronic device is released (i.e., if the display 160 is unbent as denoted by reference numeral 595), the electronic device can release the main and sub display regions set to the display 160 and display information of an application that is being executed. That is, if the wearing of the electronic device is released, the electronic device can make a screen display brightness of the whole region of the display 160 identical (for example, convert the screen display brightness of the whole region of the display 160 into a screen display brightness of the main display region 440) and display a screen. At this time, if it is a state where the electronic device is worn as denoted by reference numeral 570, a display region of the display 160 can array the main display region 440 and the sub display region 445 in a direction (i.e., 2nd direction) going from the fastening part 430b to the fastening part 430a as denoted by reference numeral 595. In case where the electronic device is worn as denoted by reference numeral 570 and the display region of the display 160 is set as denoted by reference numeral 595, if the release of the wearing of the electronic device is recognized, the electronic device can convert and display an array of display information in the 1st direction. For example, if the bending of the electronic device is released, the electronic device can array and display the display information in a direction (for example, 1st direction) going from the fastening part 430a to the fastening part 430b.

As described above, first, the electronic device can determine if the electronic device (i.e., flexible/wearable electronic device) is worn. And, if it is in the wearing state, the electronic device can determine if the main display region of the display 160 is in an initial state or extended state. The electronic device can determine a position of the fastening part in a state where the electronic device first wears the electronic device. The electronic device can determine if the fastening part is located close to the user's body or is located far away from the user's body. And, second, the electronic device can analyze a user wearing location. In the wearing state, the electronic device can determine if a position of the main display region is on the anterior surface of the user's wrist or the back side of the wrist. At this time, the electronic device can display a screen display brightness of the main display region brighter than the sub display region.

Thereafter, the electronic device can extend the main display region or transform information of the main display region in accordance with a user's touch interaction. If the electronic device recognizes a touch interaction (for example, scroll) for adjusting the main display region of an initial state in the display region of the display 160, the electronic device can sense a motion direction of the recognized touch interaction and extend or maintain the main display region. If the fastening part is located close to the user's body and a position of the main display region is on the posterior surface of the wrist, the electronic device can extend the main display region in a contents upper end direction in response to the scroll motion direction. If the fastening part is located close to the user's body and the position of the main display region is on the anterior surface of the wrist, the electronic device can extend the main display region in a contents upper end direction in response to a scroll motion direction. If the fastening part is far away from the user's body and the position of the main display region is on the posterior surface of the wrist, the electronic device can extend the main display region in a contents lower end direction in response to a scroll motion direction. If the fastening part is far away from the user's body and the position of the main display region is on the anterior surface of the wrist, the electronic device can extend the main display region in a contents lower end direction in response to a scroll motion direction.

Also, in a state where the user wears the electronic device as above, if the user releases the wearing of the electronic device and releases the bending of the electronic device (that is, if the user unbends the electronic device in a flat state), the electronic device can determine an up/down position of the electronic device in a state where the display 160 is unbent. Thereafter, the electronic device can automatically adapt a contents upper end to a device upper end position, and display contents. Here, the contents can be information displayed on the display 160 of the electronic device.

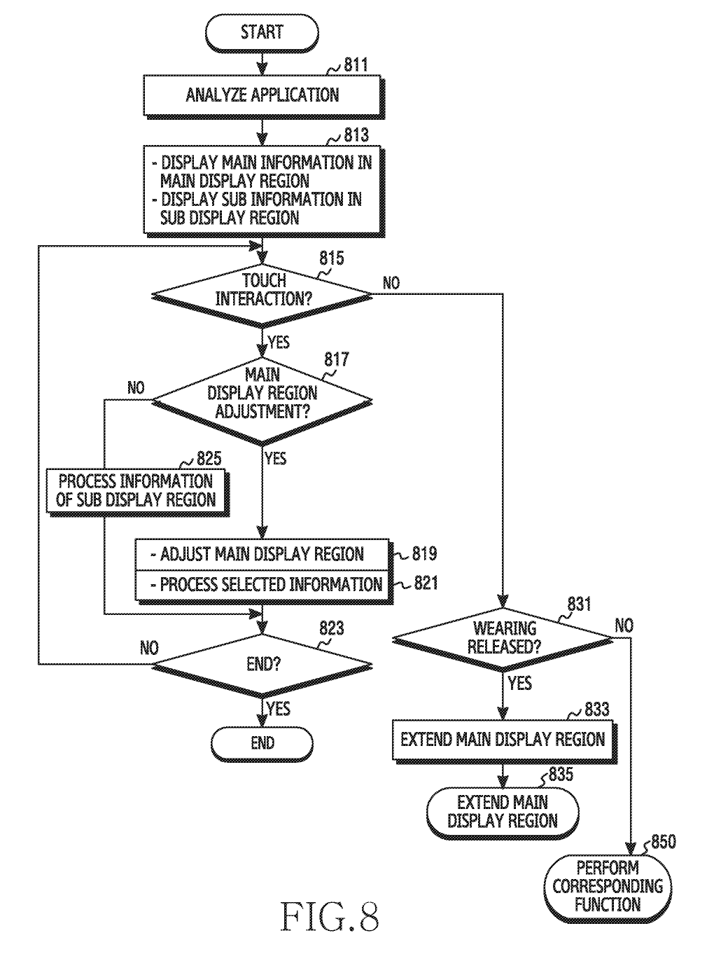

FIG. 8 is a flowchart illustrating a method of controlling a display region in accordance with a user's interaction in an electronic device according to an embodiment of the present disclosure.

Referring to FIG. 8, in operation 811, in a wearing state, the electronic device can analyze an application and determine main information and sub information. In operation 813, the electronic device can display the main information in a main display region, and display the sub information in a sub display region. And, the electronic device can display a screen of the main display region brighter than the sub display region in operation 813.

If a touch interaction occurs in the above state, in operation 815, the electronic device can analyze the type of the touch interaction. In operation 817, the electronic device can check if the recognized touch interaction is a touch interaction for adjusting the main display region or is a touch interaction for processing, in the main display region, information displayed in the sub display region. The touch interaction for adjusting the main display region can be a touch interaction for extending the main display region, and can be a touch interaction for converting the extended main interaction region into the initial main display region. At this time, if the recognized touch interaction is in the interaction for adjusting the main display region, in operation 817, the electronic device can recognize this. And, in operation 819, the electronic device can adjust the main display region. And, in operation 821, the electronic device can process information displayed in the sub display region. Here, the adjusting of the main display region can be an operation of extending the main display region or initializing the main display region. Also, if the touch interaction is not the touch interaction for adjusting the main display region, in operation 825, the electronic device can process information displayed in the sub display region. At this time, a method of processing the information of the sub display region can be a function of converting and displaying a function selected in the sub display region, in the main display region, and processing information displayed in the main display region by a user's interaction. If the electronic device performs operations 819 and 821 or operation 825, in operation 823, the electronic device can recognize this and return to operation 815, and perform a function according to a next touch interaction.

Also, if wearing release occurs in the wearing state, in operation 831, the electronic device can recognize this. And, in operation 833, if the display 160 is unbent to become in a flat state, the electronic device can extend the whole region of the display 160 as the main display region. And, in operation 835, the electronic device can perform an operation of a non-wearing state. For example, the electronic device can automatically adapt information displayed in the wearing state, to an upper end of the display 160, and display the information adapted to the upper end of the display 160. If the wearing release does not occur, in operation 850, the electronic device can perform a corresponding function. For example, the electronic device can maintain operation 815.

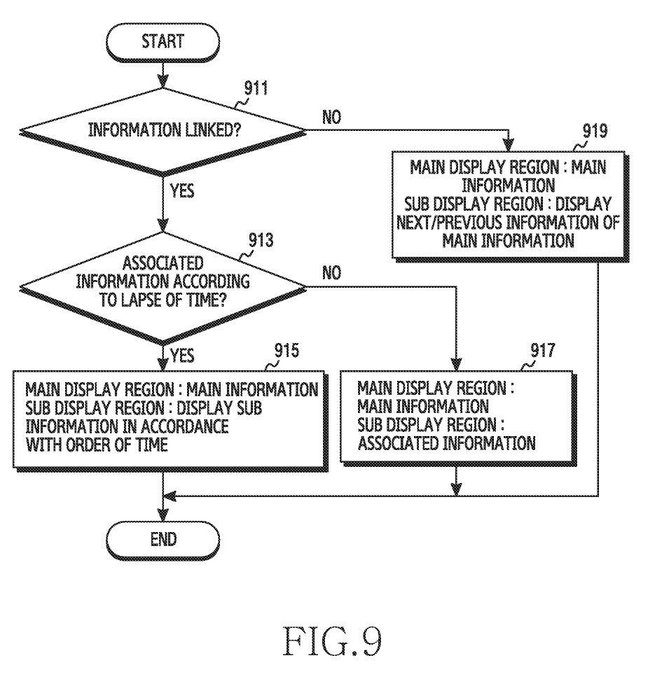

FIG. 9 is a flowchart illustrating an operation of processing information of main and sub display regions in an electronic device according to an embodiment of the present disclosure.

Referring to FIG. 9, if the electronic device is worn, the electronic device can divide the display 160 into a main display region and a sub display region in accordance with a position of the fastening part and a wearing location and display information in the main display region and the sub display region. At this time, the electronic device can analyze an executed application and analyze relationship between the information displayed in the main display region and the information displayed in the sub display region. And, if there is a relationship, the electronic device can link and display the main information and the sub information in the main display region and the sub display region, respectively. At this time, if there is not the information link, in operation 911, the electronic device can recognize this. And, in operation 919, the electronic device can display the main information in the main display region and display next/previous information of the main information in the sub display region. For example, in case where the electronic device executes a text viewer application, the electronic device can display current selected text information in the main display region, and display previous or next information of the current displayed text information in the sub display region.

However, if there is a relationship between the main information and sub information of the executed application, in operation 911, the electronic device can recognize this. And, in operation 913, the electronic device can analyze if the main information and the sub information are associated information according to time lapse. At this time, if the main information and the sub information are the information associated according to the time lapse, in operation 913, the electronic device can recognize this. And, in operation 915, the electronic device can display the main information in the main display region, and display the sub information according to time order in the sub display region. For example, in case where the electronic device performs a call application, the electronic device can display a keypad for an incoming/outgoing state or dial input in the main display region, and display a list of the latest incoming/outgoing calls in the sub display region. Also, if the main information and the sub information are not the associated information according to the time lapse, in operation 913, the electronic device can recognize this. And, in operation 917, the electronic device can display the main information in the main display region, and display the associated information in the sub display region.

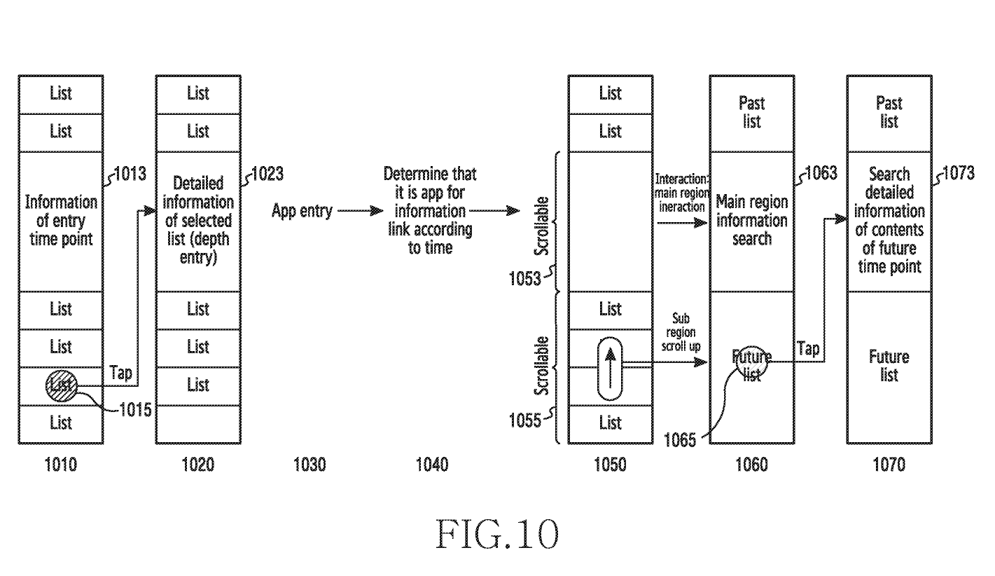

FIG. 10 is a diagram for explaining an example of displaying information in main and sub display regions in an electronic device of a wearing state according to an embodiment of the present disclosure.

Referring to FIG. 10, the electronic device of the wearing state can divide a display region of the display 160 into a main display region and a sub display region, and display the divided main display region and sub display region. At this time, main information displayed in the main display region and sub information displayed in the sub display region can have mutual relationship. And, in case where the electronic device extends the main display region, the main information and the sub information can be linked with each other. At this time, an information link criterion can distinguish if the main information and the sub information are associated with each other by application in accordance with time lapse. And, an information display criterion can display information of an executed application in the main display region, and display information associated to the application in the sub display region. For example, the electronic device can display information (for example, list) of an upper (or lower) depth of the information displayed in the main display region. For example, the electronic device can display past information compared to a current time point in an upper region of the sub display region, and can display future information compared to the current time point in a lower region of the sub display region. And, in case where the information are linked, the electronic device can display detailed information of the sub information selected in the sub display region, in the extended main display region.

In FIG. 10, illustrates an application structure 1010 of an application entry time point. In the application structure 1010, information 1013 can refer to information that can be displayed in the main display region when an application is executed. And, lists can refer to lists of information that can be displayed in the sub display region. Here, the displayed lists can refer to lists having temporal relationship with the main information. At this time, if an arbitrary list is selected among the lists as denoted by reference 1015, the electronic device can display detailed information 1023 of the selected list, in the main display region, as denoted by reference numeral 1020.

Thereafter, if the electronic device enters the application as denoted by reference numeral 1030, the electronic device can recognize that the entered application is an application in which information is linked according to time, as denoted by reference numeral 1040. Then, the electronic device can divide the main information and the sub information as denoted by reference numeral 1050. And, the electronic device can display main information 1053 selected at an application entry time point, in the main display region, and display a list 1055 of related sub information in the sub display region. At this time, the list 1055 of sub information can refer to lists that can be displayed in the main display region or the extended main display region through selection. Thereafter, in accordance with a user's interaction, as denoted by reference numeral 1060, the electronic device can display the main information in the main display region, and display a list of associated information in the sub display region. At this time, as denoted by reference numeral 1060, the displayed list of associated information can display past lists at an upper end (or lower end) position centering on a main information region 1063, and can display future lists that will be displayed in the sub display region, at a lower end (or upper end) position centering on the main information region 1063. Thereafter, if an arbitrary list is selected among the information lists displayed in the sub display region as denoted by reference numeral 1065, the electronic device can display detailed information 1073 of the selected list, in the main display region, as denoted by reference numeral 1070.

Table 1 below represents an example of applications in which the associated main information and sub information are linked to each other.

TABLE 1

| App. | Main | Sub |
|---|---|---|
| Map | Full map information. | List of each points on a moving |
| | My position on map. | route. |
| | Full route to a destination. | |
| Call | Display incoming/outgoing | List of recent incoming/outgoing |
| | state. | call. |
| | Display dialer. | |
| Calendar | Details of schedule | List of schedules of past/future |
| | (past/future/current) | (by day/week/month unit) |
| Pay | Payment screen. | List of previous payments. |
| | Detail screen of a selected | List of recommended cards on |
| | card. | current payment. |
| Alarm | Interface of an alarm | List of alarms which is off -> |
| | setting. | alarms may on in a sub. |
| | List of alarm which is on. | |
| Reminder | To do (today) | Previous work (today) |
| Music | Information of a playing | List of music played by people a |
| | music. | lot (not list of a playing music). |
| | List. | |

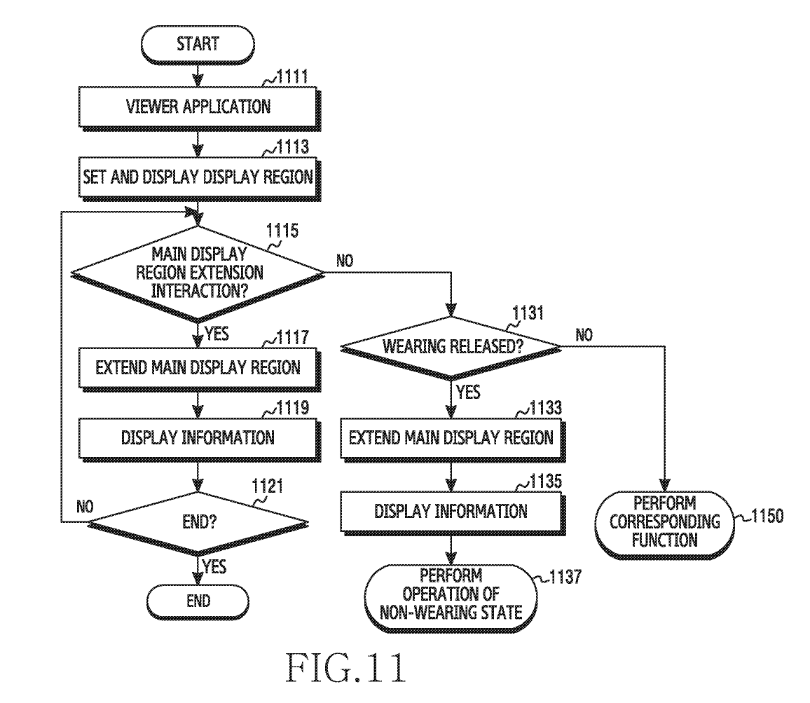

FIG. 11 is a flowchart illustrating an example of executing a viewer application in an electronic device of a wearing state according to an embodiment of the present disclosure.

Referring to FIG. 11, in operation 1111, the electronic device can be in a wearing state, and can be in a state of executing some application. The application can be a text viewer application. In operation 1113, the electronic device of the wearing state can divide the display 160 into a main display region and a sub display region, to display a text. At this time, the electronic device can display information of the main display region relatively brightly, and display information of the sub display region relatively dark compared to the main display region. If a user generates a touch interaction for extending the main display region, in operation 1115, the electronic device can recognize this. And, in operation 1117, the electronic device can extend the main display region. And, in operation 1119, the electronic device can display the text in the extended main display region.

When the electronic device extends the main display region, the electronic device can determine an extension direction of the main display region in accordance with a position of the fastening part and a user wearing location of the electronic device. For example, if the wearing location of the electronic device is on the posterior surface and the position of the fastening part is on the radial border, the electronic device can extend the main display region in a 1st direction (for example, downward direction) originating from the fastening part. For example, if the wearing location of the electronic device is on the wrist anterior surface and the position of the fastening part is on the radial border, the electronic device can extend the main display region in a 2nd direction (for example, upward direction) originating from the fastening part. Also, though not illustrated in FIG. 11, if a user's interaction (for example, swipe and/or scroll) is recognized in a direction reverse to the extension direction of the main display region in a state where the electronic device extends the main display region, the electronic device can shrink the extended main display region.

And, if a request for end of the text viewer application is generated, in operation 1121, the electronic device can recognize this and end the text viewer operation.

Also, if the release of the worn electronic device is performed, in operation 1131, the electronic device can recognize this. And, in operation 1133, the electronic device can set the whole region of the display 160 as the main display region. And, in operation 1135, the electronic device can display information of the application that is being executed. Thereafter, in operation 1137, in a non-wearing state, the electronic device can process the set application in accordance with a user's interaction. Also, if it is not the main display region extension or wearing release interaction, in operation 1150, the electronic device can perform a set function in accordance with a user's interaction.

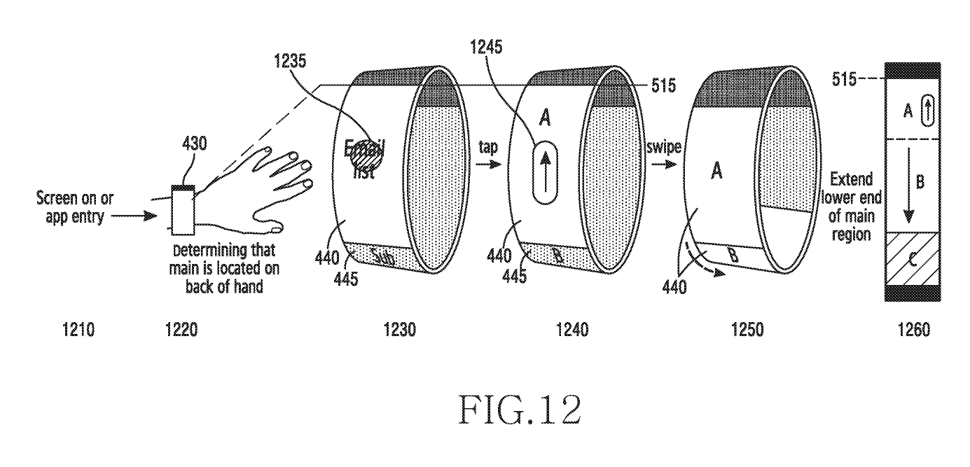

FIG. 12 is a diagram illustrating an example of execution of a viewer application in an electronic device that is worn on a posterior surface according to an embodiment of the present disclosure.

Referring to FIG. 12, the electronic device can be in the wearing state, and can turn a screen on or enter a demanded application, as denoted by reference numeral 1210. If entering the application, the electronic device can analyze a user wearing location of the electronic device and a position of the fastening part 430, and set a main display region and a sub display region. At this time, if the fastening part 430 is located on the radial border and the user wearing location is on the posterior surface as denoted by reference numeral 1220, the electronic device can set the main display region 440 in a downward direction originating from the reference line 515 of the fastening part 430, and can set a region between a lower end edge of the main display region 440 and the fastening part 430, as the sub display region 445, as denoted by reference numeral 1230. At this time, in a state where an application screen is displayed as denoted by reference numeral 1230, if a user selects a text viewer application as denoted by reference numeral 1235, the electronic device can display texts in the main display region 440 and the sub display region 445 as denoted by reference numeral 1240, respectively. At this time, the text (i.e., ‘A’ region text) displayed in the main display region 440 can be displayed relatively brightly, and the text (i.e., ‘B’ region text) displayed in the sub display region 445 can be displayed relatively dark. In the above state, if a swipe interaction is recognized as denoted by reference numeral 1245, the electronic device can extend the main display region 440 in a downward direction as denoted by reference numeral 1250, and display a text. That is, as denoted by reference numeral 1260, the electronic device can extend the main display region 440 as an ‘A’ text region and a ‘B’ text region. That is, in case where the electronic device is worn as denoted by reference numeral 1220, the main display region can be extended in a direction going from an upper end of the display 160 to a lower end of the display 160. In this case, the display 160 of the worn electronic device can display a text like the display 160 of a non-wearing state.

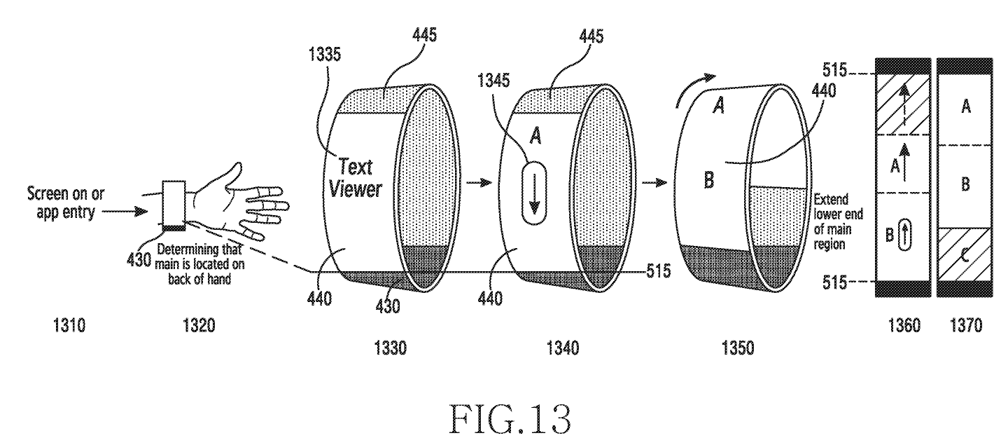

FIG. 13 is a diagram illustrating an example of execution of a viewer application in an electronic device that is worn on an anterior surface according to an embodiment of the present disclosure.

Referring to FIG. 13, the electronic device can be in the wearing state, and can turn the screen on or execute a requested application, as denoted by reference numeral 1310. If executing the application, the electronic device can analyze a user wearing location of the electronic device and a position of the fastening part 430, and set a main display region and a sub display region, as denoted by reference numeral 1320. At this time, if the fastening part 430 is located on the radial border and the user wearing location is on the anterior surface, the electronic device can set the main display region 440 in an upward direction originating from the reference line 515 of the fastening part 430, and can set a region between an upper end edge of the main display region 440 and the fastening part 430, as the sub display region 445, as denoted by reference numeral 1330. At this time, in a state where the electronic device displays an application screen as denoted by reference numeral 1330, if a user selects a text viewer application as denoted by reference numeral 1335, the electronic device can display texts in the main display region 440 and the sub display region 445 as denoted by reference numeral 1340, respectively. At this time, the text (i.e., ‘A’ region text) displayed in the main display region 440 can be displayed relatively brightly, and text data may not be displayed in the sub display region 445. That is, the electronic device can display the text in the main display region 440, and the text can be scrolled up in a sub display region 445 direction when the electronic device extends the main display region 440. Accordingly, in an initial state, the text may not be displayed in the sub display region 445. In the above state, if a swipe interaction is recognized as denoted by reference numeral 1345, the electronic device can extend the main display region 440 in an upward direction as denoted by reference numeral 1350, and display the text. That is, the electronic device can extend the main display region 440 as an ‘A’ text region and a ‘B’ text region as denoted by reference numeral 1360. That is, in case where the electronic device is worn as denoted by reference numeral 1320, the electronic device can extend the main display region in a direction going from a lower end of the display 160 to an upper end of the display 160, and can scroll up even the displayed text. In this case, it can be appreciated that the main display region 440 set to the display 160 is extended in the direction going from the lower end of the display 160 to the upper end of the display 160 as denoted by reference numeral 1360. If the user releases the wearing of the electronic device when the main display region 440 is extended as denoted by reference numeral 1360, the electronic device can extend the main display region 440, and display text information as denoted by reference numeral 1370. That is, if the electronic device is worn as denoted by reference numeral 1320, the electronic device can extend the main display region 440 in the direction going from the lower end of the display 160 to the upper end of the display 160, and a text display method can be the form of being scrolled in the direction going from the lower end to the upper end. In this case, it can be appreciated that the display 160 of the worn electronic device displays the text in a reverse direction unlike the display 160 of a non-wearing state, as denoted by reference numerals 1360 and 1370.

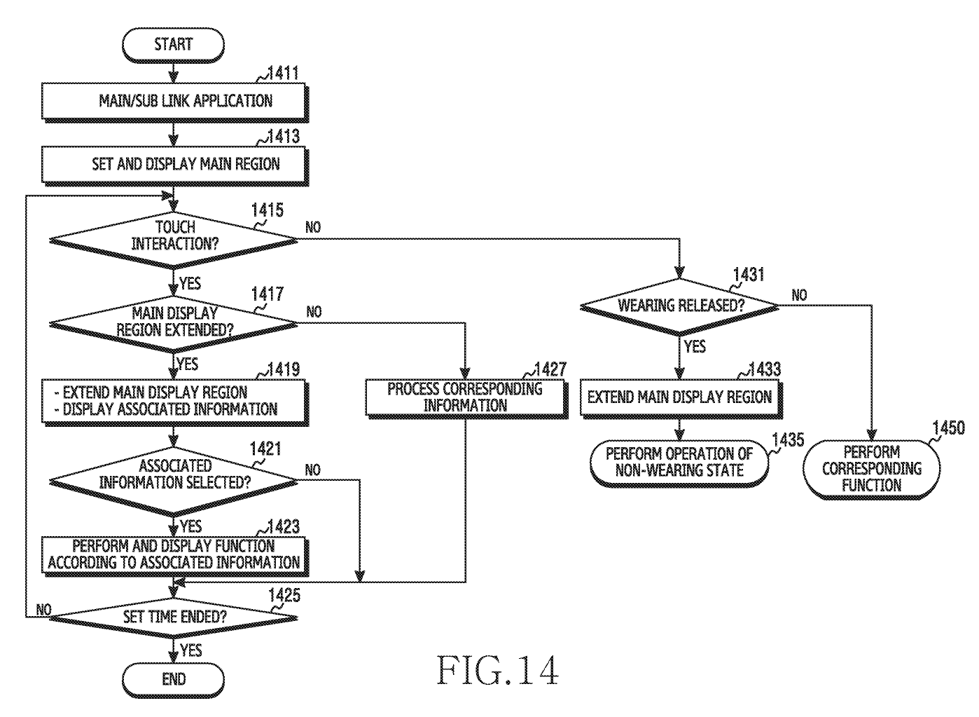

FIG. 14 is a flowchart illustrating a method of linking and displaying main information and sub information in an electronic device according to an embodiment of the present disclosure.

Referring to FIG. 14, if main information displayed in a main display region and sub information displayed in a sub display region have mutual relationship, the main information and the sub information can be linked and displayed in an extended main display region. In operation 1411, the electronic device can be in a state of executing an application of mutually linking and displaying the main information and the sub information. In operation 1413, the electronic device can be in a state of setting the main display region and the sub display region to the display 160. And, the electronic device can display the main information in the main display region and display the sub information in the sub display region. In this case, a user can execute touch interactions in the main display region and the sub display region, respectively. If the touch interaction occurs, in operation 1415, the electronic device can recognize this. And, in operation 1417, the electronic device can check if the user's touch interaction is an interaction extending the main display region. At this time, if the extension interaction (for example, scroll interaction) occurs in the sub display region, the electronic device can recognize this as the interaction extending the main display region. If the user's touch interaction is the extension interaction, in operation 1417, the electronic device can recognize this. And, in operation 1419, the electronic device can extend the main display region and can display the main information and associated information in the extended main display region. At this time, the associated information can be sub information displayed in the sub display region. And, if the associated information displayed in the extended main display region is selected, in operation 1421, the electronic device can recognize this. And, in operation 1423, the electronic device can perform and display a function according to the selected associated information. In operation 1423, the electronic device can display the linked main information and sub information in the extended main display region in accordance with the selected associated information. And, if an operation of linking the main information and the sub information is ended, the electronic device can end the operation of linking the main information and the sub information, and initialize the extended main display region. For example, in operation 1423, the electronic device can display the operation of linking the main information and the sub information in the extended main display region in accordance with the associated information. And, if a set time lapses, the electronic device can restore the extended main display region. That is, the electronic device can initialize the display 160 to the main display region and the sub display region, and differently control a display brightness of the main display region and the sub display region and decrease power consumption. Also, the application of linking and processing the main information and the sub information is ended, in operation 1425, the electronic device can recognize this and end the execution of the application.

And, if the touch interaction is not the interaction extending the main display region in operation 1417, in operation 1427, the electronic device can perform a function according to the touch interaction. For example, the touch interaction can be an interaction for display control (for example, zoom in or zoom out) of the main display region, an interaction for initialization, etc. of the extended main display region, etc.

If the user releases the wearing of the electronic device, in operation 1431, the electronic device can recognize this. And, in operation 1433, the electronic device can extend the whole region of the display 160 as the main display region. Thereafter, in operation 1435, the electronic device can perform an operation that is set in a non-wearing state. Also, if the user's interaction generated in a state of executing the application is not an interaction linking and processing the main information and the sub information, in operation 1450, the electronic device can perform a corresponding function.

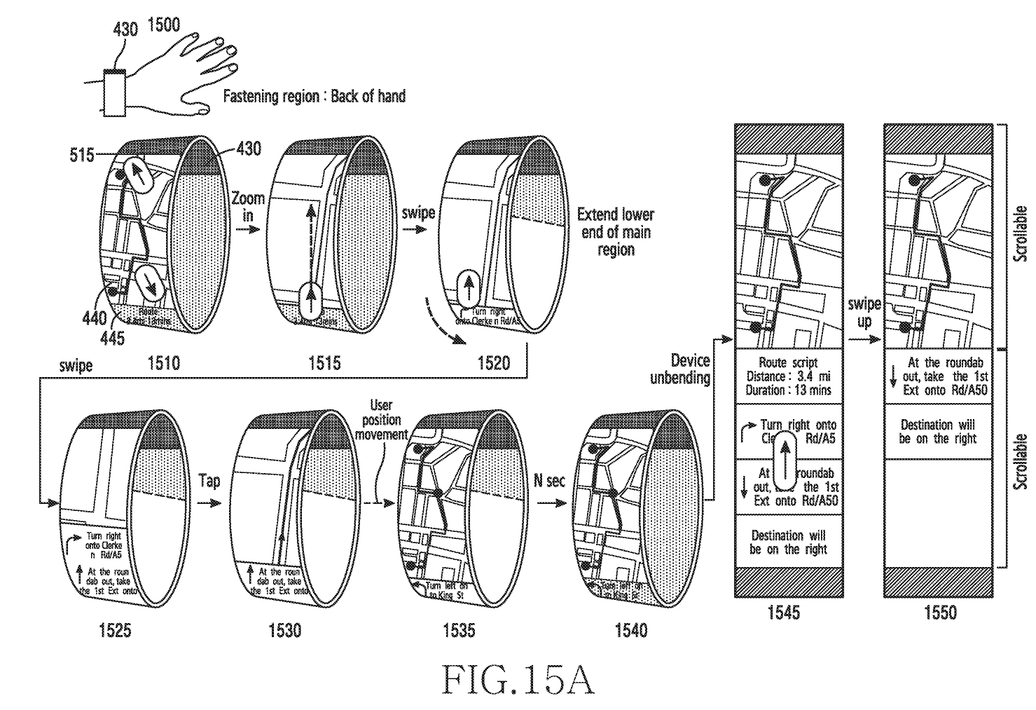

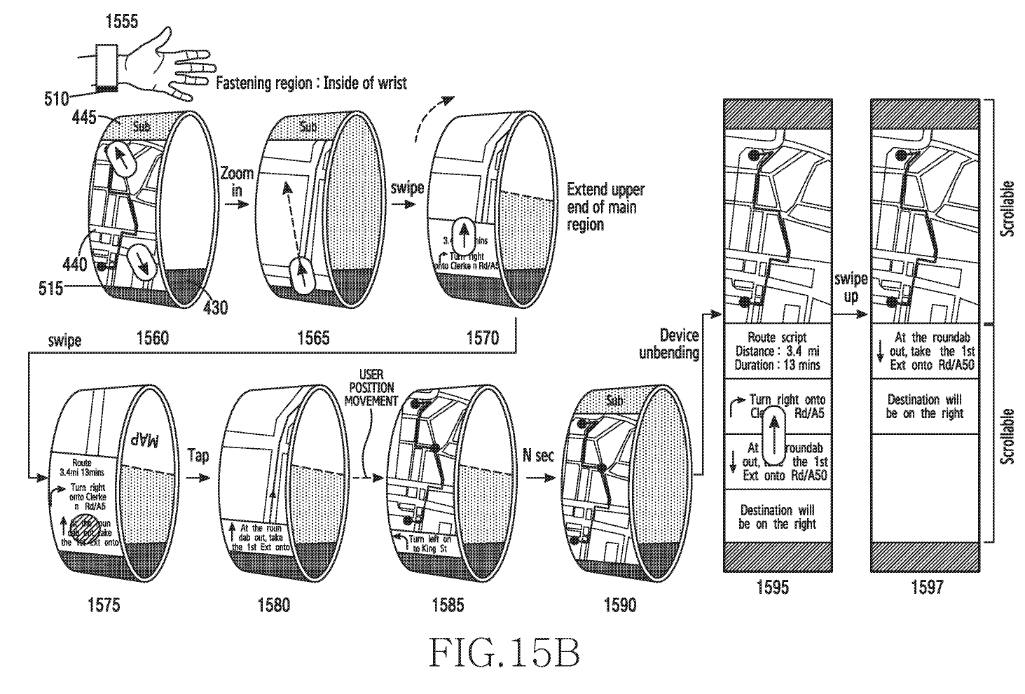

FIGS. 15A and 15B are diagrams illustrating an example of processing a map application while wearing an electronic device according to various embodiments of the present disclosure.

Referring to FIG. 15A, an example of execution of a map application is illustrated when the electronic device is worn as denoted by reference numeral 1500. The electronic device can recognize the execution of the map application. And, the electronic device can set (split) the display 160 as the main display region 440 and the sub display region 445 as denoted by reference numeral 1510. At this time, map information that is main information can be displayed in the main display region 440, and sub information that can be linked with the main information can be displayed in the sub display region 445. Here, the sub information can be navigation information on a movement route. At this time, if a zoom-in interaction (for example, pinch zoom-in interaction) occurs in the main display region 440 as denoted by reference numeral 1515, the electronic device can recognize that it is a zoom-in interaction of the main display region. And, the electronic device can magnify and display the map information displayed in the main display region as denoted by reference numeral 1515. Also, if a swipe interaction going from the sub display region 445 to the main display region 440 occurs, the electronic device can recognize that it is an extension of the main display region 440. And, the electronic device can extend the main display region as denoted by reference numeral 1520. At this time, since the user is in a state of wearing the electronic device as denoted by reference numeral 1500, the electronic device can extend the main display region in a downward direction of a reference line that is a boundary between the fastening part 430 and the main display region 440. At this time, the electronic device can control to brightly display even the sub information located in the extended main display region as denoted by reference numeral 1525.

Thereafter, if the sub information (for example, route information) of the extended main display region is selected (i.e., a tap interaction) as denoted by reference numeral 1525, the electronic device can link and display the route information as denoted by reference numeral 1530. Thereafter, if the user moves, the electronic device can sense information (i.e., navigation information) related to the user's movement from the sensor unit 130. And, the electronic device can link and display the route information according to the user's movement in a map position displayed in the main display region 440 as denoted by reference numeral 1535. And, if a set time lapses, the electronic device can initialize a display region of the display 160 to the main display region 440 and the sub display region 445 as denoted by reference numeral 1540 (i.e., shrink the extended main display region).

Also, if the user releases the wearing of the electronic device in course of executing the map application, the electronic device can convert the whole display region of the display 160 into the main display region as denoted by reference numerals 1545 and 1550. That is, if the user releases the wearing of the electronic device, the user is in a state capable of viewing the whole region of the display 160, so the electronic device can control the whole region of the display 160 by a display brightness of the main display region 440.

At this time, if the wearing state is converted into the wearing-release state, the electronic device can automatically move the main information (for example, map information) to an upper region of the display 160 as denoted by reference numeral 1545, and control the main information and the sub information by separate layers. For example, the electronic device can display the main information at an upper layer and display the sub information at a lower layer. A screen brightness of the main information and the sub information can be all displayed brightly. The main information and the sub information can be controlled by a touch interaction. For example, if a swipe-up interaction occurs in a region displaying the sub information as denoted by reference numeral 1545, the electronic device can scroll the sub information although the swipe-up interaction is laid over a region displaying the main information as denoted by reference numeral 1550.

Also, FIG. 15B is a diagram illustrating an example of execution of a map application in a state in which the electronic device is worn as denoted by reference numeral 1555. The electronic device can recognize the execution of the map application, and can set the display 160 as the main display region 440 and the sub display region 445 as denoted by reference numeral 1560. At this time, the main information can be map information, and the sub information can be information that can link with the main information. At this time, the sub display region 445 can be in an upward direction of the main display region 440. And, if it is a state where the main display region 440 is not extended, the sub display region 445 can be in a state where information is not displayed as denoted by reference numeral 1565.

At this time, if a zoom-in interaction occurs in the main display region 440 as denoted by reference numeral 1560, the electronic device can recognize that it is an interaction for zoom-in of the main display region 440, and magnify and display the map information displayed in the main display region 440 as denoted by reference numeral 1565. Also, if a swipe interaction going from the fastening part 430 to the main display region 440 occurs, the electronic device can recognize that it is an extension of the main display region 440, and extend the main display region as denoted by reference numeral 1570. At this time, a user is in a state of wearing the electronic device as denoted by reference numeral 1555, so the electronic device can extend the main display region 440 in an upward direction of a reference line that is a boundary between the fastening part 430 and the main display region 440. That is, a display region located upper than the main display region 400 can be a sub display region, and the main display region can be extended in the upward direction. At this time, the electronic device can control to display brightly even the sub information located in the extended main display region as denoted by reference numeral 1570.

Thereafter, if the sub information (for example, route information) of the extended main display region is selected (i.e., tap interaction) as denoted by reference numeral 1575, the electronic device can link and display the route information as denoted by reference numeral 1580. Thereafter, if the user moves, the electronic device can sense information (i.e., navigation information) related to the user's movement from the sensor unit 130. And, the electronic device can link and display the route information according to the user's movement in a map position displayed in the main display region 440 as denoted by reference numeral 1585. And, if a set time lapses, the electronic device can initialize a display region of the display 160 to the main display region 440 and the sub display region 445 as denoted by reference numeral 1590 (shrink the extended main display region).

Also, if the user releases the wearing of the electronic device in course of executing the map application, the electronic device can convert the whole display region of the display 160 into the main display region as denoted by reference numerals 1595 and 1597. That is, if the user releases the wearing of the electronic device, the user is in a state capable of viewing the whole region of the display 160, so the electronic device can control the whole region of the display 160 by a display brightness of the main display region 440 at wearing.

At this time, if the wearing state is converted into the wearing-release state, the electronic device can automatically move the main information (for example, map information) to an upper region of the display 160 as denoted by reference numeral 1595, and control the main information and the sub information by separate layers. In case where the user wears the electronic device as denoted by reference numeral 1555, the main display region set to the display 160 can be a lower region of the display 160. This can be a direction reverse to a display direction of the display 160 at wearing release. Accordingly, if the wearing is released in a state where the electronic device is worn as denoted by reference numeral 1555, the electronic device can arrange a displayed information array in a reverse direction as denoted by reference numeral 1595. In other words, the electronic device can arrange, in an upper region of the unbent display 160, the main information located at a lower end of the worn display 160. Also, the electronic device can display the main information at an upper layer and display the sub information at a lower layer. A screen brightness of the main information and the sub information can be all displayed brightly. The main information and the sub information can be controlled by a touch interaction. For example, if a swipe-up interaction occurs in a region displaying the sub information as denoted by reference numeral 1595, the electronic device can scroll only the sub information although the swipe-up interaction is laid over a region displaying the main information as denoted by reference numeral 1597.

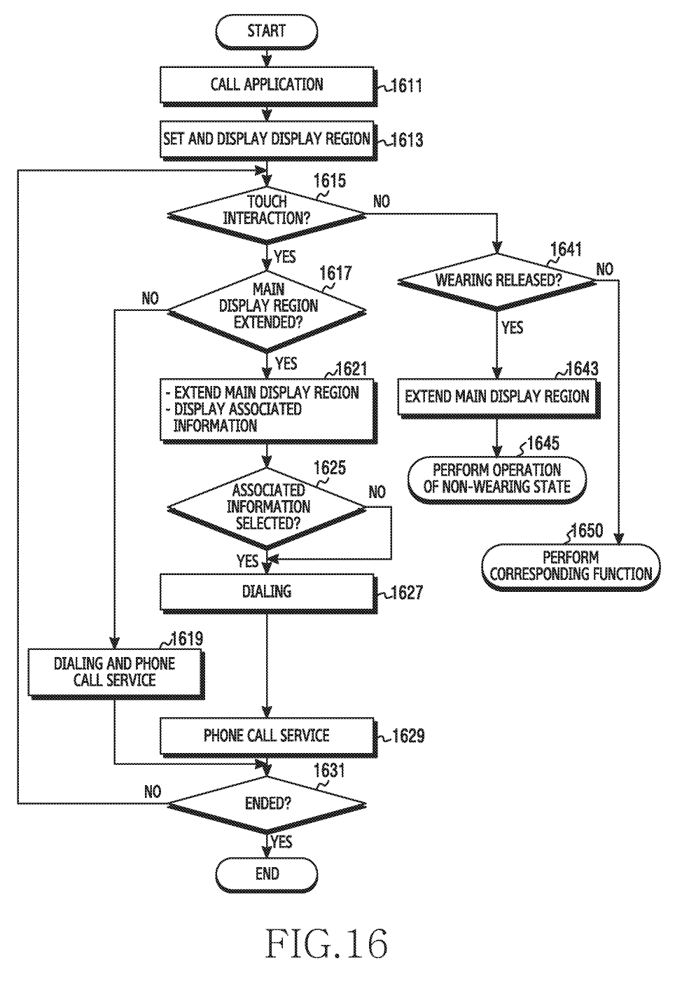

FIG. 16 is a flowchart illustrating a method of linking and displaying main information and sub information in an electronic device according to an embodiment of the present disclosure.

Referring to FIG. 16, if the call application is executed, in operation 1611, the electronic device can recognize this. And, in operation 1613, the electronic device can set a main display region and a sub display region to the display 160. If a user's touch interaction for extending the main display region occurs, in operation 1615 and operation 1617, the electronic device can recognize this. And, in operation 1621, the electronic device can extend the main display region, and display associated sub information in the extended main display region. Here, the main information can be a dialing keypad, and the sub information can be the latest telephony history list. At this time, if a specific phone number is selected from the displayed latest telephony history list, in operation 1625, the electronic device can recognize this. And, in operation 1627, the electronic device can dial the selected phone number. And, if a counterpart subscriber responds, in operation 1629, the electronic device can perform a phone call service. Also, in a state where the latest telephony history list is displayed, a user can perform a dialing motion through a phone number keypad. If so, in operation 1627, the electronic device can perform a dialing operation according to received information. And, in operation 1629, the electronic device can perform the phone call service. Also, if the task switching application is ended, in operation 1631, the electronic device can recognize this and end the execution of the application.

Also, in a state in which the main display region and the sub display region are set to the display 160, the user can perform a dialing motion by using a phone number keypad displayed in the main display region. If so, in operation 1617, the electronic device senses reception of phone number information. And, in operation 1619, the electronic device can perform a dialing operation and provide a phone call service. Also, in a state in which the main display region and the sub display region are selected from the display 160, the user can perform a dialing operation by using a contact list. In this case, in operation 1617, the electronic device can recognize this. And, in operation 1619, the electronic device can display the contact list in the main display region, and dial a phone number of the selected contact list and perform a phone call service operation.

If the user releases the wearing of the electronic device, in operation 1641, the electronic device can recognize this. And, in operation 1643, the electronic device can set the whole region of the display 160 as the main display region. And, in operation 1645, the electronic device can perform a call processing operation of a non-wearing state in accordance with a user's interaction.

If the user does not release the wearing of the electronic device, in operation 1650, the electronic device can perform a corresponding function.

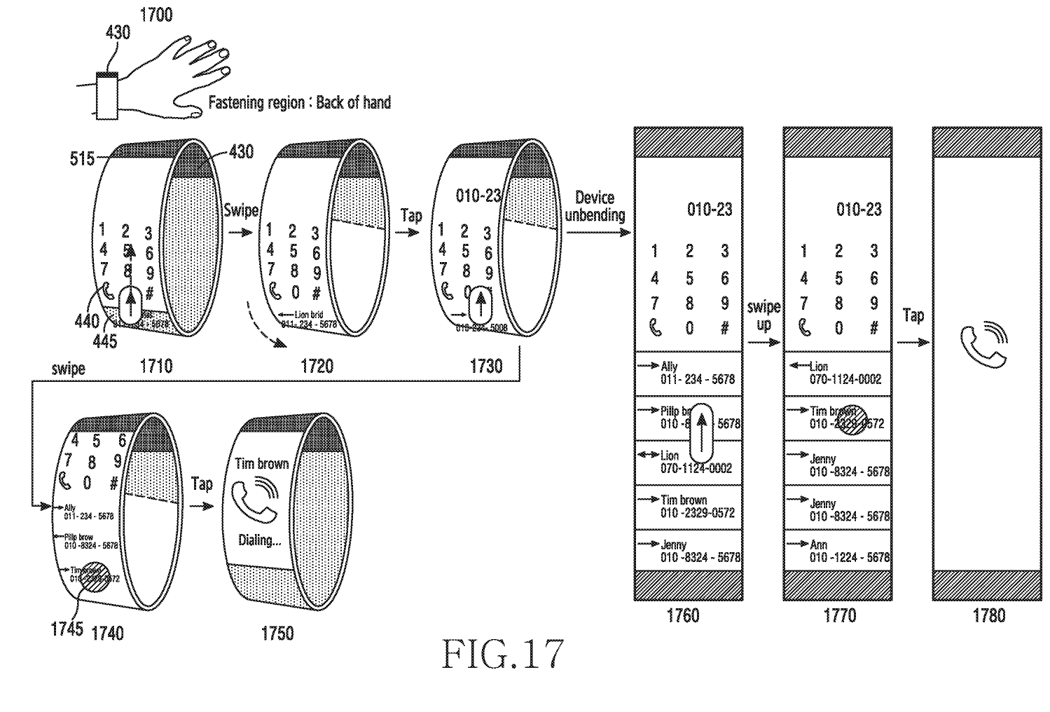

FIG. 17 is a diagram illustrating an example of processing a call processing application while wearing an electronic device according to an embodiment of the present disclosure.

Referring to FIG. 17, an example is illustrated of execution of a call processing application in a state in which the electronic device is worn as denoted by reference numeral 1700. The electronic device can recognize the execution of the call processing application. And, the electronic device can set the display 160 as the main display region 440 and the sub display region 445 as denoted by reference numeral 1710. At this time, keypad information that can input a phone number that is main information can be displayed in the main display region 440, and sub information that can link with the main information can be displayed in the sub display region 445. Here, the sub information can be the latest telephony history list information. At this time, if a swipe interaction going from the sub display region 445 to the main display region 440 occurs, the electronic device can recognize that the swipe interaction is for an interaction for an extension of the main display region 440, and extend the main display region 440 as denoted by reference numeral 1720. At this time, a user is in a state of wearing the electronic device as denoted by reference numeral 1700, so the electronic device can extend the main display region 440 in a downward direction of a reference line 515 that is a boundary between the fastening part 430 and the main display region 440. At this time, the electronic device can control to brightly display even the sub information located in the extended main display region as denoted by reference numeral 1720.

In the state denoted by reference numeral 1720, if a touch input is sensed from a keypad of the extended main display region, the electronic device can display a corresponding numeral. For example, if numerals ‘0’, ‘1’, ‘0’, ‘2’, ‘3’ are continuously touched on the keypad, the electronic device can output ‘010-23’ to an upper part of the keypad as denoted by reference numeral 1730.

And, if the user continuously generates a swipe interaction as denoted by reference numeral 1730, the electronic device can scroll the extended main display region as denoted by reference numeral 1740. That is, the electronic device can scroll the dialing keypad of the extended main display region and the sub information (for example, the latest telephony history) in an upward direction.

Thereafter, if the user selects a specific phone number of the latest telephony history as denoted by reference numeral 1745, the electronic device can perform a dialing operation as denoted by reference numeral 1750. And, if a counterpart subscriber responds, the electronic device can perform a phone call service.

Also, if the user releases the wearing of the electronic device in course of executing the call processing application, the electronic device can convert the whole display region of the display 160 into the main display region as denoted by reference numeral 1760. That is, if the user releases the wearing of the electronic device, the user is in a state capable of viewing the whole region of the display 160, so the electronic device can control the whole region of the display 160 by a display brightness of the main display region at wearing.

At this time, if the wearing state is converted into the wearing-release state, the electronic device can automatically move the main information (for example, keypad for inputting the phone number) to an upper region of the display 160 as denoted by reference numeral 1760, and control the main information and the sub information by separate layers. For example, the electronic device can display the main information at an upper layer and display the sub information at a lower layer. A screen brightness of the main information and the sub information can be all displayed brightly. The main information and the sub information can be controlled by a touch interaction. For example, if a swipe interaction (i.e., a swipe-up interaction denoted by reference numeral 1760) occurs in a region displaying the sub information, the electronic device can scroll only the sub information as denoted by reference numeral 1770. And, if an arbitrary phone number is selected (i.e., tap interaction denoted by reference numeral 1770) among the sub information, the electronic device can dial the selected phone number as denoted by reference numeral 1780.

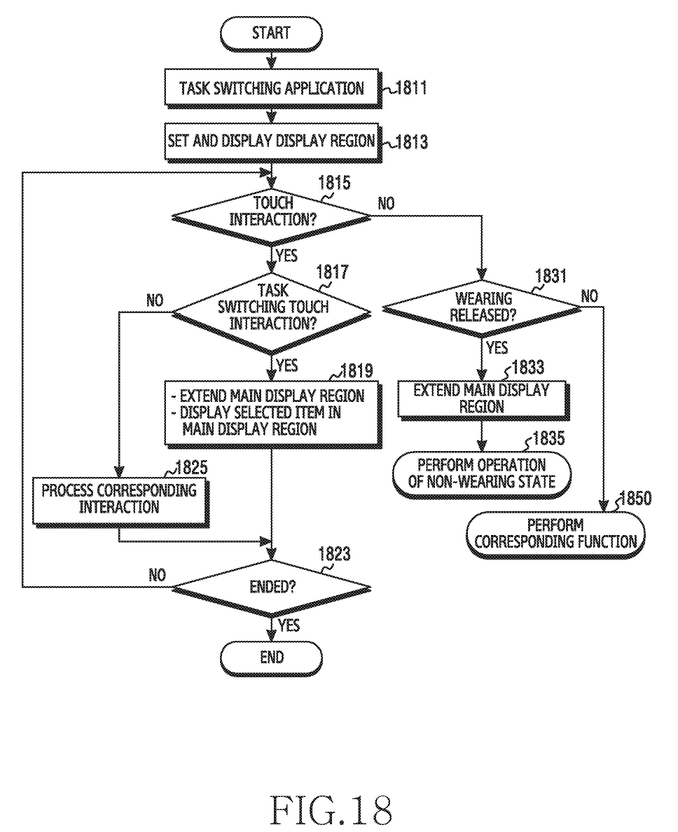

FIG. 18 is a flowchart illustrating a method of performing a task switching operation in an electronic device according to an embodiment of the present disclosure.

Referring to FIG. 18, the electronic device can temporarily task switch and display main information without interrupting the displaying of the main information displayed in an extended main display region. In operation 1811, the electronic device can be in a state of executing an application that can temporarily task switching and displaying another information in a main display region. For example, the task switching application can be a message processing application. Here, the message processing application can be applications using a contact list, such as an SMS, an SNS, an EMS, an MIMS, etc., and a keypad.

In operation 1813, the electronic device can set a main display region and a sub display region in accordance with a position of a fastening part and a wearing location of the electronic device.

If a touch interaction occurs, in operation 1815, the electronic device can recognize this. And, in operation 1817, the electronic device can check if the touch interaction is a task switching interaction for switching information displayed in the main display region. At this time, if the task switching interaction (for example, interaction tapping a task switching item displayed in the main display region) occurs, the electronic device can recognize this as the task switching interaction. If the user's touch interaction is the task switching interaction, in operation 1817, the electronic device can recognize this. And, in operation 1819, the electronic device can extend the main display region, and display detailed information of a selected task switching item, as main information, in the extended main display region. And, a user can select desired information among the detailed information of the task switching item displayed in the extended main display region. If the user selects the desired information, in operation 1817, the electronic device can recognize this. And, in operation 1825, the electronic device can perform an operation corresponding to the selected information.

When the electronic device executes a task switching application, the electronic device can extend the main display region by the task switching interaction, and display detailed information of a task that the user selects, in the extended main display region. If arbitrary information is selected among the detailed information displayed in the extended main display region, the electronic device can perform an operation according to the selected information. And, if the task switching operation is completed or an input is not recognized a constant time, the electronic device can initialize the extended main display region. Also, if the task switching application is ended, in operation 1823, the electronic device can recognize this and end the execution of the application.

If the user releases the wearing of the electronic device, in operation 1831, the electronic device can recognize this. And, in operation 1833, the electronic device can extend the whole region of the display 160 as the main display region. Thereafter, in operation 1835, the electronic device can perform an operation that is set in a non-wearing state. Also, if the user's interaction generated in a state of executing the application is not an interaction linking and processing the main information and the sub information, in operation 1850, the electronic device can perform a corresponding function.

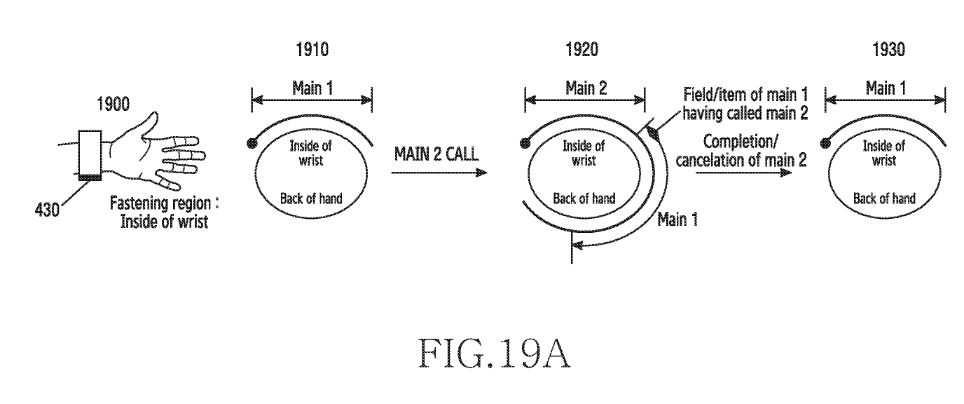

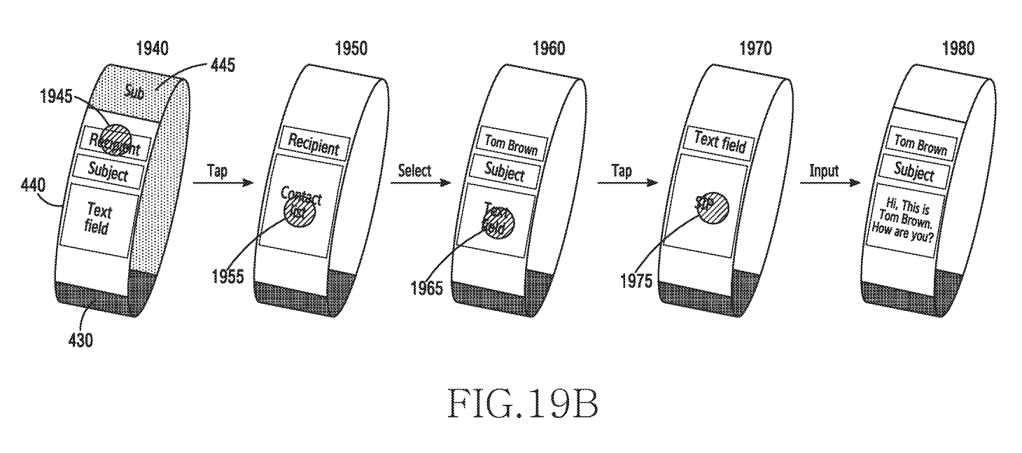

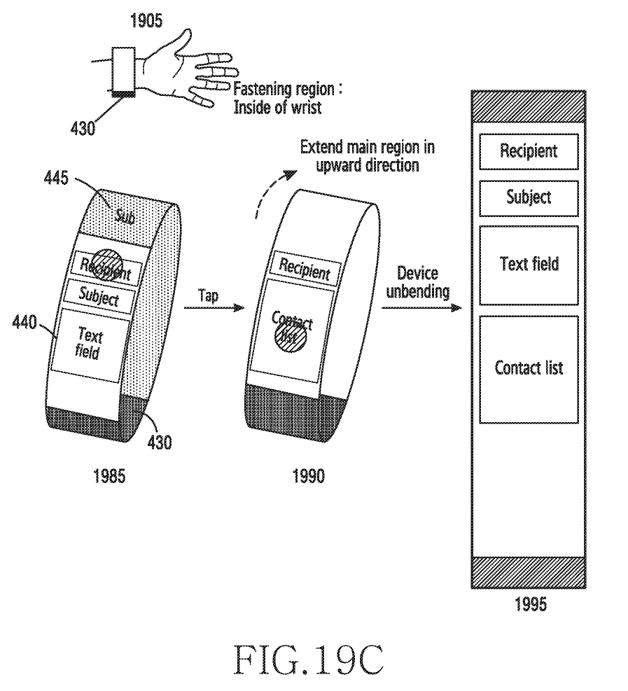

FIGS. 19A, 19B, and 19C are diagrams illustrating an example of task switching operations of FIG. 18 according to various embodiments of the present disclosure.

Referring to FIG. 19A, the user can wear the electronic device as denoted by reference numeral 1900. If the electronic device is worn as denoted by reference numeral 1900, the electronic device can set a main display region to the anterior surface of the wrist and set a sub display region to the posterior surface of the wrist (i.e., back-of-hand direction), as denoted by reference numeral 1910. And, if an interaction for extension of the main display region is recognized, the electronic device can extend the main display region to the posterior surface as denoted by reference numeral 1920. At this time, the initial main information can be scrolled and displayed in the extended main display region, and sub information displayed in the sub display region can be displayed in the extended main display region. Here, the sub information displayed in the extended main display region can be information located anterior to or following the main information (for example, in a case of a viewer application, viewer information located anterior to/following the main information), information associated with the main information (for example, sub information (i.e., information related to time, a position, etc.) linking with the main information), detailed information of task-switched sub information, etc. In reference numeral 1920, ‘Main 1’ can be the main information, and ‘Main 2’ can be the sub information displayed in the extended main display region. And, if displaying of the extended main display region is completed or canceled, the electronic device can initialize the display region of the display 160 as denoted by reference numeral 1930. In this case, the electronic device can again set the main display region and the sub display region.

Referring to FIG. 19A, an example of a case where the electronic device is worn as denoted by reference numeral 1900 is illustrated. However, the electronic device can be worn as denoted by reference numeral 1500 of FIG. 15A or reference numeral 1700 of FIG. 17. Even when the electronic device is worn such that the main display region is in the back-of-hand direction, the electronic device can extend the main display region in a method similar to FIG. 19A, and display corresponding sub information in the extended main display region. At this time, the extension direction of the main display region can be extended from the posterior surface to the anterior surface.

Referring to FIG. 19B, the electronic device can be worn as denoted by reference numeral 1900 of FIG. 19A, and an executed application can be a message processing application.

In a state where the electronic device is worn as denoted by reference numeral 1900, if the message processing application is executed, the electronic device can set the main display region 440 and the sub display region 445 to the display 160 as denoted by reference numeral 1940. At this time, the main information can be displayed such as a recipient, a subject, and/or a text field. And, the sub display region 445 can be in an upward direction of the main display region 440. And, if it is a state where the main display region 440 is not extended, the sub display region 445 can be in a state where information is not displayed.

At this time, if a task switching item (here, recipient) is selected in the main display region 440 as denoted by reference numeral 1945, the electronic device can recognize that it is an extension of the main display region 440, and display detailed information of the task switching item in the main display region 440 as denoted by reference numeral 1950. Here, the detailed information of the task switching item can be a contact list. At this time, a user is in a state of wearing the electronic device as denoted by reference numeral 1900, so the electronic device can extend the main display region in an upward direction of a reference line that is a boundary between the fastening part 430 and the main display region 440.

Thereafter, if sub information (for example, information of the contact list) of the extended main display region is selected (e.g., tap interaction) as denoted by reference numeral 1955, the electronic device can display a selected subscriber of the contact list in the recipient item as denoted by reference numeral 1960. Also, in a state where the selected subscriber is displayed as denoted by reference numeral 1960, if the user selects a text field as denoted by reference numeral 1965, the electronic device recognizes this as a task switching touch interaction, and display a keypad (for example, Samsung input panel (SIP)) 1975 for inputting a text, in the extended main display region, as denoted by reference numeral 1970. And, if the text is inputted through the keypad, the electronic device can display the inputted text in the extended main display region as denoted by reference numeral 1980.

Referring to FIG. 19B, the electronic device can support a temporary task switching operation in a state where the electronic device maintains the displaying of main information in the extended main display region. For example, when the electronic device executes an application capable of inputting a text, if an interaction for calling a common module/intent (for example, a text keypad, a picker, a clipboard, attachments, etc.) necessary for text input is generated by the user, the electronic device can extend the main display region, and provide the temporarily called common module to the extended main display region. And, a display region of a common module field displayed in the extended main display region can be different in size in accordance with an attribute of the called common module. Also, an input field of the common module can be kept in a region adjacent to the called common module, such that the user can check content that the user inputs. And, fields other than the focused input field can be temporarily displayed in the sub display region while an input motion is performed, so the user can use a wide screen display region. Thereafter, in case where the input is completed or canceled, the displaying of the temporarily called input field can be ended.

Referring to FIG. 19C, in a state where the electronic device is worn as denoted by reference numeral 1905, the electronic device can switch a task while displaying selected information in the extended main display region as denoted by reference numerals 1985 and 1990. At this time, if the wearing of the electronic device is released, the electronic device can convert the whole display region of the display 160 into the main display region as denoted by reference numeral 1995. That is, if the user releases the wearing of the electronic device, the user is in a state capable of viewing the whole region of the display 160, so the electronic device can control the whole region of the display 160 by a display brightness of the main display region at wearing. At this time, if the wearing state is converted into the wearing-release state, the electronic device can arrange and display information displayed in the wearing state, from an upper region of the display 160 to a lower region of the display 160, as denoted by reference numeral 1995.

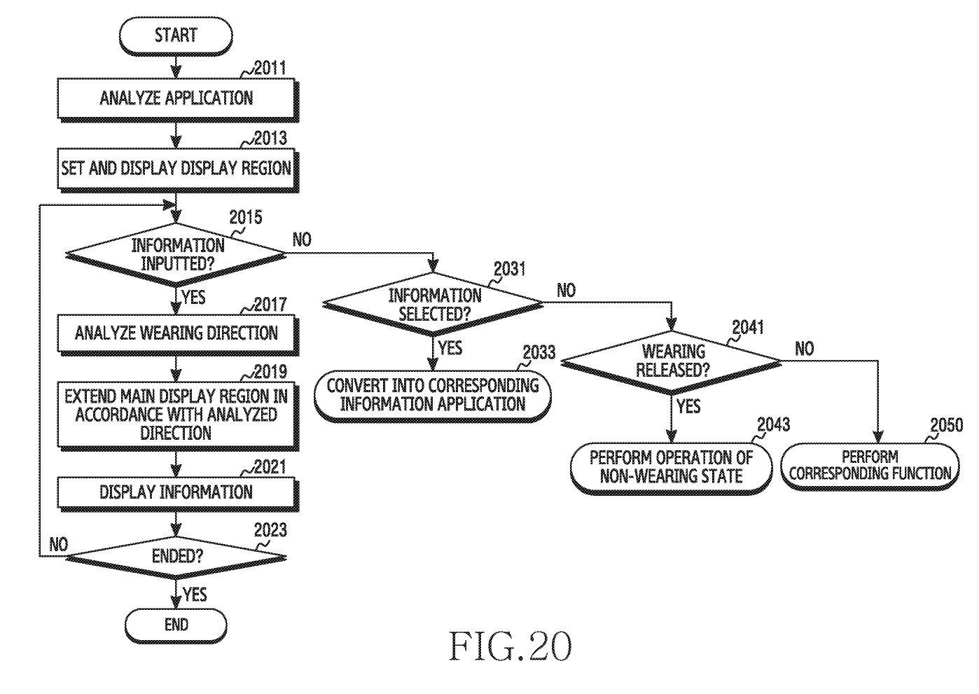

FIG. 20 is a flowchart illustrating a method of extending a main display region in an electronic device according to an embodiment of the present disclosure.

Referring to FIG. 20, an application acquiring external information can be a camera application, a contents downloading application, etc. In operation 2011, the electronic device of a wearing state can analyze an executed application. And, in operation 2013, the electronic device can set a main display region and a sub display region in accordance with a position of a fastening part of the electronic device and a wearing location of the electronic device. At this time, the application can be an application capable of continuously inputting or acquiring external contents. If information is inputted, in operation 2015, the electronic device can recognize this. And, in operation 2017, the electronic device can analyze the wearing location of the electronic device. And, in operation 2019, the electronic device can extend the main display region in accordance with the analyzed wearing location. And, in operation 2021, the electronic device can display the inputted information in the extended main display region. And, if the execution of a corresponding application is ended, in operation 2023, the electronic device can recognize this and end the execution of the application.

Also, if the displayed information is selected, in operation 2031, the electronic device can recognize this. And, in operation 2033, the electronic device can convert to an application for processing the corresponding information. Also, if the wearing of the electronic device is released in course of processing the application, in operation 2041, the electronic device can recognize this. And in operation 2043, the electronic device can initialize the setting of the display region and perform an operation of a non-wearing state. And, if another input other than the information input, the selection of the displayed information, and/or the wearing release is sensed, in operation 2050, the electronic device can perform a corresponding function.

An application capable of continuously inputting or acquiring information can be an application downloading contents, an application acquiring an image through a camera, etc.

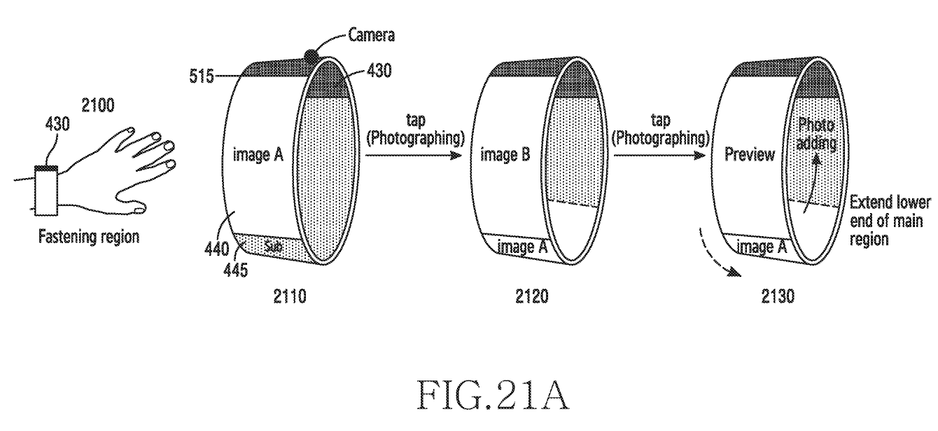

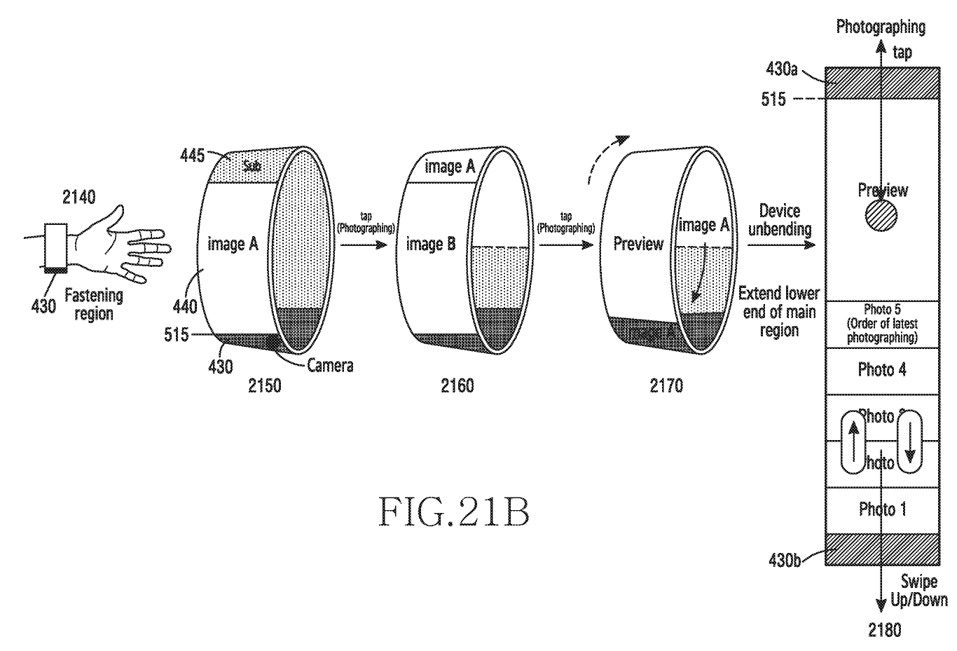

FIGS. 21A and 21B are diagrams illustrating examples of extending a main display region in an electronic device according to various embodiments of the present disclosure.

Referring to FIG. 21A, if the electronic device is worn as denoted by reference numeral 2100 and an executed application is a camera application, the electronic device can display an image (for example, image A) acquired through the camera unit 140, as a preview image, in a main display region 440. At this time, the main display region 440 can be set in a downward direction of a reference line 515 that is a boundary line between the fastening part 430 and the display 160, and the sub display region 445 can be set in a downward direction of the main display region 440. In a state where the preview image (e.g., image A) is displayed as denoted by reference numeral 2110, if a user generates a photographing interaction (for example, a tap interaction of a region where the preview image is displayed), the electronic device can recognize an information input, and analyze a wearing location (i.e., an extension direction of the main display region). And then, as denoted by reference numeral 2120, the electronic device can extend the main display region 440 and display an inputted image. For example, the electronic device can scroll and display the image A (i.e., photographed image) in the downward direction as denoted by reference numeral 2120, and display an image B acquired through the camera unit 140, as a preview image, in the extended main display region. In such a method, as denoted by reference numeral 2130, the electronic device can extend the main display region 440 in the downward direction of the reference line while displaying acquired images.

Referring to FIG. 21B, if the electronic device is worn as denoted by reference numeral 2140 and an executed application is a camera application, the electronic device can display an image (for example, image A) acquired through the camera unit 140, as a preview image, in the main display region 440. At this time, the main display region 440 can be set in an upward direction of the reference line 515 that is a boundary line between the fastening part 430 and the display 160, and the sub display region 445 can be set in an upward direction of the main display region 440. If a user generates a photographing interaction in a state where the preview image (e.g., image A) is displayed as denoted by reference numeral 2150, the electronic device can recognize an information input, and analyze a wearing location (i.e., extension direction of the main display region). And then, as denoted by reference numeral 2160, the electronic device can extend the main display region 440 in the upward direction and display an inputted image. For example, the electronic device can scroll and display the image A (i.e., photographed image) in the upward direction as denoted by reference numeral 2160, and display an image B acquired through the camera unit 140, as a preview image, in the extended main display region. In such a method, as denoted by reference numeral 2170, the electronic device can extend the main display region 440 in the upward direction of the reference line while displaying acquired images.

If the wearing of the electronic device is released in the above display state, the electronic device can recognize the release of the wearing of the electronic device, and display as denoted by reference numeral 2180. That is, if the wearing is released, the electronic device can activate the whole region of the display 160, and can display images from an upward direction of the display 160 to a downward direction. At this time, the electronic device can display a preview image in an upper region of the display 160, and display photographed images in a lower region of the display 160.

For example, in case where the electronic device is worn as denoted by reference numeral 2140 and the main display region 440 is located on the anterior surface of the wrist, the main display region 440 can be extended from a downward direction of the display 160 to an upward direction. In this state, if the wearing is released, the electronic device can arrange a displayed information array in a reverse direction (i.e., arrange in an upper region of the unbent display 160 a main information array located at a lower end of the worn display 160) as denoted by reference numeral 2180. Also, the electronic device can display information (for example, preview image) displayed in the main display region, at an upper layer, and display sub information (for example, photographed images) at a lower layer. And, a screen brightness of the main information and sub information displayed on the display 160 can be all displayed brightly. The main information and the sub information can be controlled by a touch interaction. For example, if a swipe-up/down interaction is generated in a region displaying the sub information as denoted by reference numeral 2180, the electronic device can scroll up/down the sub information.

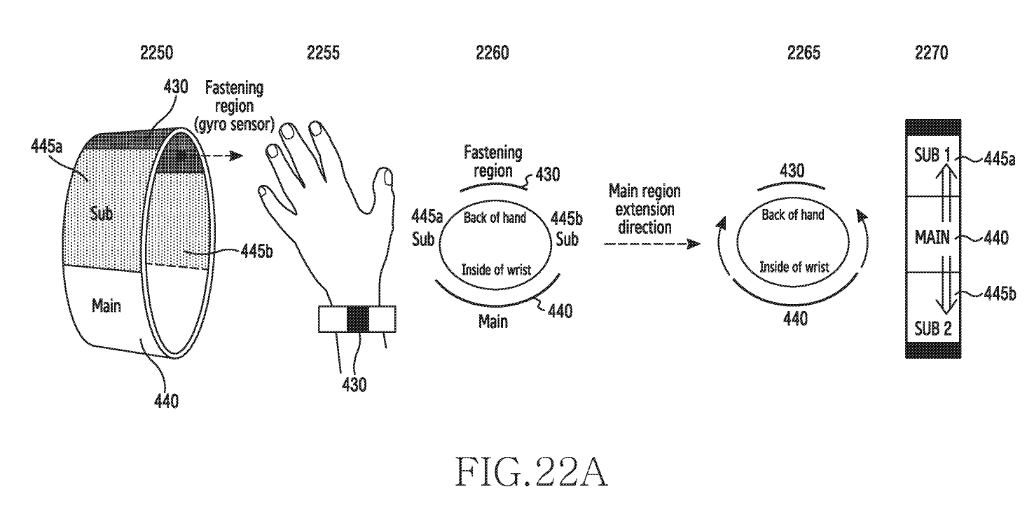

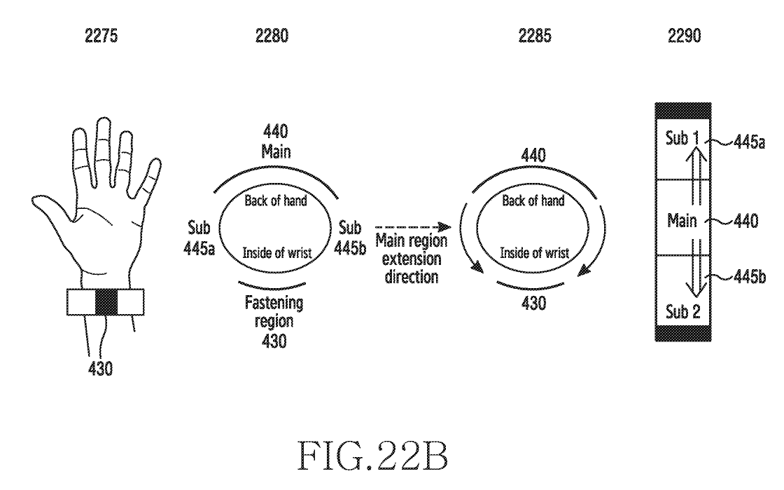

FIGS. 22A and 22B are diagrams illustrating examples of setting a display region while wearing an electronic device according to various embodiments of the present disclosure.

The fastening part 430 of the electronic device can perform a function of fastening both ends of the electronic device when the electronic device is worn. When the electronic device is worn, the fastening part 430 can be located on either radial border of the wrist as mentioned above. If the fastening part 430 is located as above, the electronic device can analyze a wearing location of the electronic device when setting the main display region 440 and the sub display region 445. And then, the electronic device can extend the main display region 440 in one direction (i.e., direction going from the anterior surface to the posterior surface, or direction going from the posterior surface to the anterior surface) from a user visible region.

However, when the user wears the electronic device, the user can wear the electronic device such that a position of the fastening part 430 is located on the anterior surface of the wrist or the posterior surface of the wrist. In this case, when the electronic device sets the main display region 440 and the sub display region 445, the electronic device can set the main display region 440 in a position opposite the position of the fastening part 430 in a worn state. And, the electronic device can set regions of the display 160 between the main display region 440 and the fastening part 430, as sub display regions 445a and 445b.

Referring to FIG. 22A, if the user wears the electronic device as denoted by reference numeral 2255, the fastening part 430 can be located at the wrist of the back-of-hand direction, and the user visible region can be on the anterior surface of the wrist. Accordingly, if the user wears the electronic device such that the fastening part 430 is located in the back-of-hand direction of the wrist, the electronic device can set the main display region 440 in a position of the display 160 that is in a direction opposite the fastening part 430 in the wearing state, as denoted by reference numeral 2265. And, the electronic device can set the regions of the display 160 between the main display region 440 and the fastening part 430, as the sub display regions 445a and 445b. Reference numeral 2250 denotes the main display region 440 and the sub display regions 445a and 445b that are set to the worn electronic device. Reference numeral 2270 denotes the form of the main display region 440 and the sub display regions 445a and 445b that are set to the display 160 of the wearing state.

In a state where the main display region 440 and the sub display regions 445a and 445b are set as denoted by reference numeral 2260, if an interaction of extending the main display region 440 is generated, the electronic device can extend the main display region 440 towards the sub display region 445a or 445b. Here, the extension interaction can be a swipe interaction as mentioned above. Also, the extension interaction can be a user's motion. For example, if the user rotates the wrist, the electronic device can recognize a user's wrist rotation and a rotation direction by a gyro sensor of the sensor unit 130 and/or an acceleration sensor thereof. And, if the wrist rotation is recognized, the electronic device can extend the main display region by the sub display region of the rotation direction.

Referring to FIG. 22B, if the user wears the electronic device as denoted by reference numeral 2275, the fastening part 430 can be located on the anterior surface of the wrist and the user visible region can be located on the posterior surface of the wrist. Accordingly, if the user wears the electronic device such that the fastening part 430 is located on the anterior surface, the electronic device can set the main display region 440 in a position of the display 160 that is in a direction opposite to the fastening part 430, as denoted by reference numeral 2285. And, the electronic device can set regions of the display 160 between the main display region 440 and the fastening part 430, as sub display regions 445a and 445b. Reference numeral 2290 denotes the form of the main display region 440 and the sub display regions 445a and 445b that are set to the display 160 of the wearing state.

In a state where the main display region 440 and the sub display regions 445a and 445b are set as denoted by reference numeral 2280, if an interaction of extending the main display region 440 is generated, the electronic device can extend the main display region 440 towards the sub display region 445a or 445b. Here, the extension interaction can be a swipe interaction as mentioned above. Also, the extension interaction can be a user's motion. And, if the user's wrist rotation is recognized, the electronic device can extend the main display region by the sub display region of a direction in which the wrist is rotated.

A method for operating in an electronic device having a flexible display, according to various embodiments of the present disclosure may comprises recognizing the wearing of the electronic device; recognizing a position of a fastening part of the worn electronic device and setting a display region of the display; and displaying screen information in the set display region.

The method may further comprise the operation of recognizing a wearing location of the electronic device, and the operation of setting the display region sets a user visible region according to the position of the fastening part and the wearing location, as a main display region, and sets the remaining display region of the display as a sub display region.

The operation of displaying the screen information further comprises the operation of displaying the main display region displaying main information, more brightly than the sub display region displaying sub information.

The operation of setting the display region comprises the operations of: if the position of the fastening part is on the radial border and the wearing location is on the anterior surface of the wrist, setting the main display region in an upward direction originating from the fastening part, and setting the remaining region of the display as the sub display region; and if an extension interaction is recognized, extending the main display region in the upward direction.

The operation of setting the display region comprises the operations of, if the position of the fastening part is on the radial border and the wearing location is on the posterior surface, setting the main display region in a downward direction originating from the fastening part, and setting the remaining region of the display as the sub display region; and extending the main display region in the downward direction if an extension interaction is recognized.

The main information and the sub information are viewer information, and the operation of displaying the screen information displays previous or next viewer information in the main display region that is extended if an extension interaction is recognized.

The main information and the sub information are linked information, and the operation of displaying the screen information displays the sub information in the main display region that is extended if an extension interaction is recognized.

The main information comprises task switching information, and the operation of displaying the screen information displays the selected task switching information in the main display region that is extended if a selection of the task switching information is recognized.

The main information is external input information, and the operation of displaying the screen information displays the external input information in the main display region that is extended if the external input information is recognized.

If the position of the fastening part is on the anterior surface or the posterior surface, the operation of displaying the screen information sets a display region of a position opposite the fastening part as the main display region, and sets remaining display regions between the main display region and the fastening part as 1st and 2nd sub display regions.

An electronic device and an operation method thereof according to various embodiments of the present disclosure can determine a situation of when the electronic device is transformed and convert into a suitable function/UI, in the flexible electronic device transformable into a phone and wearable form. Also, the electronic device and the operation method thereof according to various embodiments of the present disclosure determine user's wearing or non-wearing when bending is recognized in situations of non-wearing and wearing of the flexible electronic device, and differently control the electronic device in accordance with each situation.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a flexible display; and
a processor operatively coupled to the display and configured to:
detect a position of a fastening part of the electronic device,
set a display region of the display, and
display screen information in the display region.

2. The device of claim 1, wherein the processor is further configured to:
detect wearing of the electronic device,
analyze the position of the fastening part and a wearing location of the electronic device,
set a user visible region as a main display region, and
set a remaining display region of the display as a sub-display region.

3. The device of claim 2, wherein the processor is further configured to display main information in the main display region and sub-information on the sub-display region, wherein the main display region is brighter than the sub-display region.

4. The device of claim 3, wherein, if the position of the fastening part is on a radial border of the wrist and the wearing location is on an anterior surface of the wrist, the processor is further configured to:
set the main display region in an upward direction originating from the fastening part,
set the remaining region of the display as the sub-display region, and
extend the main display region in the upward direction if an extension interaction is detected.

5. The device of claim 3, wherein, if the position of the fastening part is on a radial border of the wrist and the wearing location is on a posterior surface of the wrist, the processor is further configured to:
set the main display region in a downward direction originating from the fastening part,
set the remaining region of the display as the sub-display region, and
extend the main display region in the downward direction if an extension interaction is detected.

6. The device of claim 3,
wherein the main information and the sub information are viewer information, and
wherein if an extension interaction is detected, the processor is further configured to:
extend the main display region towards the sub-display region, and
display previous viewer information or next viewer information in the extended main display region.

7. The device of claim 3,
wherein the main information and the sub information are linked information, and
wherein if an extension interaction is detected, the processor is further configured to:
extend the main display region towards the sub-display region, and
display the sub information in the extended main display region.

8. The device of claim 3, wherein the main information comprises task switching information, and
wherein, if a selection of the task switching information is detected, the processor is further configured to:
extend the main display region towards the sub-display region, and
display the selected task switching information in the extended main display region.

9. The device of claim 3,
wherein the main information is external input information, and
wherein, if detecting the external input information, the processor is further configured to:
extend the main display region towards the sub-display region, and
display the external input information in the extended main display region.

10. The device of claim 3, wherein, if the position of the fastening part is on an anterior surface or a posterior surface of the wrist, the processor is further configured to:
set a display region of a position opposite the fastening part as the main display region, and
set remaining display regions between the main display region and the fastening part as a first sub-display region and a second sub-display region.

11. A method for operating an electronic device having a flexible display, the method comprising:
detecting wearing of the electronic device;
detecting a position of a fastening part of the electronic device;
setting a display region of the display; and
displaying screen information in the display region.

12. The method of claim 11, further comprising detecting a wearing location of the electronic device,
wherein the setting of the display region comprises:
determining a user visible region according to the position of the fastening part and the wearing location,
setting the user visible region as a main display region, and
setting a remaining display region of the display as a sub-display region.

13. The method of claim 12, wherein the displaying of the screen information further comprises displaying main information on the main display region and sub information on the sub-display region, wherein the main display region is brighter than the sub-display region.

14. The method of claim 13, wherein the setting of the display region comprises:
if the position of the fastening part is on a radial border of the wrist and the wearing location is on an anterior surface of the wrist, setting the main display region in an upward direction originating from the fastening part, and setting the remaining region of the display as the sub-display region; and
if an extension interaction is recognized, extending the main display region in the upward direction.

15. The method of claim 13, wherein the setting of the display region comprises:
if the position of the fastening part is on a radial border of the wrist and the wearing location is on a posterior surface of the wrist, setting the main display region in a downward direction originating from the fastening part, and setting the remaining region of the display as the sub-display region; and
extending the main display region in the downward direction if an extension interaction is recognized.

16. The method of claim 13,
wherein the main information and the sub-information comprise viewer information, and
wherein the displaying of the screen information comprises displaying previous viewer information or next viewer information in the main display region that is extended if an extension interaction is recognized.

17. The method of claim 13,
wherein the main information and the sub-information are linked, and
wherein the displaying of the screen information comprises displaying the sub information in the main display region that is extended if an extension interaction is recognized.

18. The method of claim 13,
wherein the main information comprises task switching information, and
wherein the displaying of the screen information comprises displaying the selected task switching information in the main display region that is extended if a selection of the task switching information is recognized.

19. The method of claim 13,
wherein the main information is external input information, and
wherein the displaying of the screen information comprises displaying the external input information in the main display region that is extended if the external input information is recognized.

20. The method of claim 13, wherein, if the position of the fastening part is on an anterior surface or a posterior surface of the wrist, the displaying the screen information comprises:
setting a display region of a position opposite the fastening part as the main display region; and
setting remaining display regions between the main display region and the fastening part as a first sub-display region and a second sub-display region.
